(19) United States
(12) Patent Application Publication
(10) Pub. No.: US 2022/0309999 A1
(43) Pub. Date: Sep. 29, 2022

(54) IMAGE DISPLAY DEVICE, DISPLAY CONTROL DEVICE, IMAGE PROCESSING DEVICE, AND RECORDING MEDIUM

(71) Applicant: Mitsubishi Electric Corporation, Tokyo (JP)

(72) Inventor: Toshiaki KUBO, Tokyo (JP)

(73) Assignee: Mitsubishi Electric Corporation, Tokyo (JP)

(21) Appl. No.: 17/633,586

(22) PCT Filed: Sep. 5, 2019
(86) PCT No.: PCT/JP2019/034941

§ 371 Date: Feb. 8, 2022

(51) Int. Cl. G09G 3/32

(52) U.S. Cl. CPC G09G 3/32; G09G 2330/045; G09G 2360/16

(57) ABSTRACT

A display control device includes an image processing device that makes an image display display an image according to input image data and a temperature measurement unit that measures a temperature of a light emitter having the same property as light-emitting elements of the image display. A temperature of each light-emitting element is estimated based on a lighting ratio and a measured temperature of the light emitter and the input image data, and the input image data is corrected based on the estimated temperature. The estimation of the temperature is performed based on a result of learning a relationship among the input image data, the lighting ratio and a temperature measurement value of the light emitter, and a temperature measurement value of a previously designated light-emitting element of the image display.

### TECHNICAL FIELD

The present invention relates to an image display device, a display control device and an image processing device. The present invention relates also to a program and record medium. In particular, the present invention relates to a technology for correcting irregularity of luminance or color of a display panel.

### BACKGROUND ART

There has been known a display panel in which light-emitting elements, each formed with a combination of red, green and blue LEDs, are arranged like a matrix as pixels.

In general, a light-emitting element formed with LEDs has variations in the luminance or the color of the generated light. Further, the luminance or the color of the generated light changes depending on the temperature. Thus, there are cases where irregularity of the luminance or the color occurs to the display image.

Patent Reference 1 proposes a method in which the temperature of LEDs of backlight of a liquid crystal display panel is measured by using a temperature sensor and image data is corrected by using correction data for each temperature.

### PRIOR ART REFERENCE

### Patent Reference

Patent Reference 1: WO 2011-125374 (paragraphs 0045 and 0050 to 0053, FIG. 1)

### SUMMARY OF THE INVENTION

### Problem to be Solved by the Invention

In a display panel in which a plurality of light-emitting elements are arranged like a matrix, an electric current fed to each light-emitting element varies depending on the display content, and thus the temperature of each light-emitting element becomes different from each other. When the temperature of each light-emitting element becomes different from each other, luminance irregularity or color irregularity can occur. This is because the luminance or the color changes depending on the temperature in each light-emitting element formed with LEDs.

While the temperature sensor is provided on the backlight of the liquid crystal display panel in the technology of the Patent Reference 1 as mentioned above, applying this idea to a display panel including a plurality of light-emitting elements requires to provide the temperature sensor on each light-emitting element. Therefore it leads to an increase in the number of temperature sensors, the wiring, and the space for the installation.

An object of the present invention is to provide a display control device capable of compensating for the change in at least one of the luminance and the color of each light-emitting element due to the temperature change even if the temperature sensor is not provided for each light-emitting element.

### Means for Solving the Problem

An image display device according to the present invention includes:

an image display in which a plurality of light-emitting elements each including a plurality of LEDs are arranged;

an image processing device that makes the image display display an image according to input image data; and

a control-dedicated temperature measurement module that measures a temperature of a light emitter having a same property as the plurality of light-emitting elements of the image display or a light-emitting element previously selected among the plurality of light-emitting elements of the image display, wherein

the image processing device estimates a temperature of each of the plurality of light-emitting elements of the image display based on a lighting ratio of the light emitter or the selected light-emitting element, the temperature measured by the control-dedicated temperature measurement module, and the input image data,

the image processing device corrects the input image data based on the estimated temperature so that a change in at least one of luminance and color due to a temperature change is compensated for in regard to each of the plurality of light-emitting elements of the image display, and

the estimation of the temperature is performed based on a result of learning a relationship among the input image data, the lighting ratio of the light emitter or the selected light-emitting element, a temperature measurement value of the light emitter or the selected light-emitting element, and a temperature measurement value of at least one previously designated light-emitting element of the image display.

A display control device according to the present invention includes:

an image processing device that makes an image display, in which a plurality of light-emitting elements each including a plurality of LEDs are arranged, display an image according to input image data; and

a control-dedicated temperature measurement module that measures a temperature of a light emitter having a same property as the plurality of light-emitting elements of the image display or a light-emitting element previously selected among the plurality of light-emitting elements of the image display, wherein

the image processing device estimates a temperature of each of the plurality of light-emitting elements of the image display based on a lighting ratio of the light emitter or the selected light-emitting element, the temperature measured by the control-dedicated temperature measurement module, and the input image data,

the image processing device corrects the input image data based on the estimated temperature so that a change in at least one of luminance and color due to a temperature change is compensated for in regard to each of the plurality of light-emitting elements of the image display, and

the estimation of the temperature is performed based on a result of learning a relationship among the input image data, the lighting ratio of the light emitter or the selected light-emitting element, a temperature measurement value of the light emitter or the selected light-emitting element, and a temperature measurement value of at least one previously designated light-emitting element of the image display.

An image processing device according to the present invention is an image processing device that makes an image display, in which a plurality of light-emitting elements each including a plurality of LEDs are arranged, display an image according to input image data, including:

a temperature estimation unit that estimates a temperature of each of the plurality of light-emitting elements of the image display based on a lighting ratio of a light emitter having a same property as the plurality of light-emitting elements of the image display or a light-emitting element previously selected among the plurality of light-emitting elements of the image display, a temperature of the light emitter or a temperature measurement value of the selected light-emitting element, and the input image data; and

a temperature compensation unit that corrects the input image data based on the estimated temperature so that a change in at least one of luminance and color due to a temperature change is compensated for in regard to each of the plurality of light-emitting elements of the image display,

wherein the temperature estimation unit performs the estimation of the temperature based on a result of learning a relationship among the input image data, the lighting ratio of the light emitter or the selected light-emitting element, a temperature measurement value of the light emitter or the selected light-emitting element, and a temperature measurement value of at least one previously designated light-emitting element of the image display.

### Effects of the Invention

According to the present invention, the temperature of each light-emitting element can be estimated based on the input image data, and the change in at least one of the luminance and the color of each light-emitting element due to the temperature change can be compensated for even if the temperature sensor is not provided for each light-emitting element.

### BRIEF DESCRIPTION OF THE DRAWINGS

FIG. 1 is a diagram showing an image display device in a first embodiment of the present invention.

FIGS. 2(a) and 2(b) are diagrams showing an example of a change in luminance and color depending on a temperature of a light-emitting element.

FIG. 3 is a diagram showing a computer that implements functions of an image processing device shown in FIG. 1, together with an image display, a light emitter and a control-dedicated temperature measurement module.

FIG. 4 is a block diagram showing a configuration example of a temperature estimation unit shown in FIG. 1.

FIG. 5 is a diagram showing an example of a neural network forming an estimate calculation unit shown in FIG. 4.

FIG. 6 is a block diagram showing a configuration example of a temperature compensation unit shown in FIG. 1.

FIGS. 7(a) and 7(b) are diagrams showing an example of the relationship between an input and an output defined by a compensation table stored in a compensation table storage unit shown in FIG. 5.

FIG. 8 is a flowchart showing a procedure of a process executed by a processor in a case where the functions of the image processing device shown in FIG. 1 are implemented by the computer.

FIG. 9 is a block diagram showing the image display device of FIG. 1, a learning device and a learning-dedicated temperature measurement module.

FIG. 10 is a flowchart showing a procedure of a process in learning executed by using the learning device shown in FIG. 9.

FIG. 11 is a diagram showing an image display device in a second embodiment of the present invention.

FIG. 12 is a block diagram showing a configuration example of a temperature estimation unit shown in FIG. 11.

FIG. 13 is a diagram showing an example of a neural network forming an estimate calculation unit shown in FIG. 12.

FIG. 14 is a flowchart showing a procedure of a process executed by the processor in a case where functions of an image processing device shown in FIG. 11 are implemented by the computer.

FIG. 15 is a diagram showing an image display device in a third embodiment of the present invention.

FIG. 16 is a block diagram showing a configuration example of a temperature estimation unit shown in FIG. 15.

FIG. 17 is a flowchart showing a procedure of a process executed by the processor in a case where functions of an image processing device shown in FIG. 15 are implemented by the computer.

FIG. 18 is a diagram showing an image display device in a fourth embodiment of the present invention.

FIG. 19 is a block diagram showing a configuration example of a variation correction unit shown in FIG. 18.

FIG. 20 is a flowchart showing a procedure of a process executed by the processor in a case where functions of an image processing device shown in FIG. 18 are implemented by the computer.

FIG. 21 is a diagram showing an image display device in a fifth embodiment of the present invention.

FIG. 22 is a diagram showing an example of a neural network forming a temperature estimation unit shown in FIG. 21.

FIG. 23 is a flowchart showing a procedure of a process executed by the processor in a case where functions of an image processing device shown in FIG. 21 are implemented by the computer.

FIG. 24 is a block diagram showing the image display device of FIG. 21, a learning device and a learning-dedicated temperature measurement module.

FIG. 25 is a flowchart showing a procedure of a process in learning executed by using the learning device shown in FIG. 24.

FIG. 26 is a diagram showing an image display device in a sixth embodiment of the present invention.

FIG. 27 is a block diagram showing a configuration example of a temperature estimation unit shown in FIG. 26.

FIG. 28 is a block diagram showing the image display device of FIG. 26, a learning device and a learning-dedicated temperature measurement module.

FIG. 29 is a flowchart showing a procedure of a process in learning executed by using the learning device shown in FIG. 28.

### MODE FOR CARRYING OUT THE INVENTION

### First Embodiment

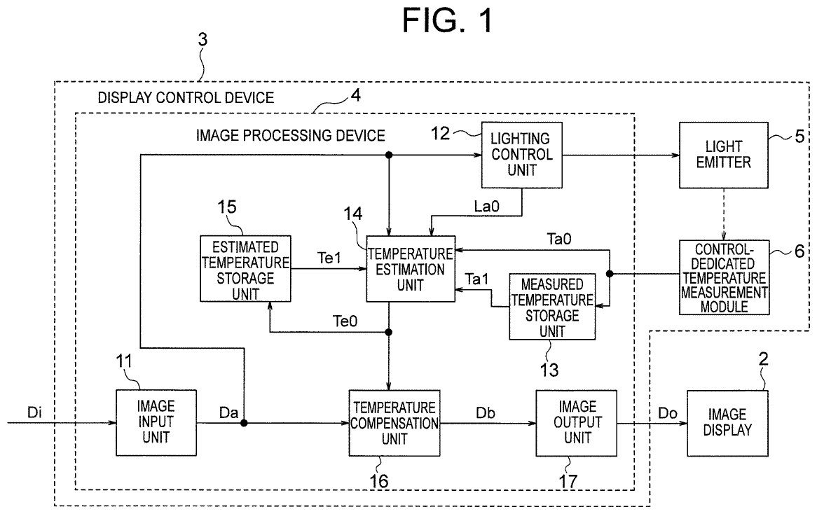

FIG. 1 shows an image display device in a first embodiment of the present invention. The image display device in the first embodiment includes an image display 2 and a display control device 3. The display control device 3 includes an image processing device 4, a light emitter 5 and a control-dedicated temperature measurement module 6.

The image display 2 is formed with a display including a display panel in which red, green and blue Light-Emitting Diodes (LEDs) are arranged. For example, one light-emitting element is formed by a combination of red, green and blue LEDs, and the display panel is formed with a plurality of such light-emitting elements regularly arranged like a matrix as pixels. For example, each light-emitting element is an element called a 3-in-1 LED light-emitting element in which a red LED chip, a green LED chip and a blue LED chip are provided in one package.

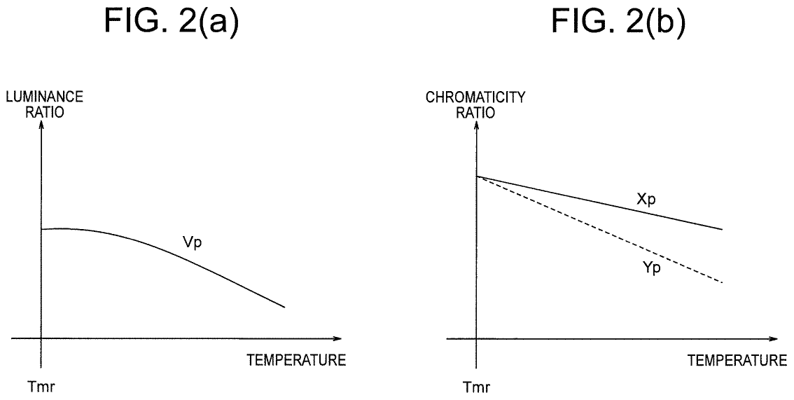

The light-emitting element formed with LEDs changes in both or one of the luminance and the color of the generated light depending on the temperature. The color is represented by chromaticity, for example. FIG. 2(a) shows an example of the change in a luminance Vp depending on the temperature. FIG. 2(b) shows an example of the change in the chromaticity depending on the temperature. The chromaticity is represented by an X stimulus value and a Y stimulus value in the CIE-XYZ color model, for example. FIG. 2(b) shows the change in a X stimulus value Xp and a Y stimulus value Yp.

FIGS. 2(a) and 2(b) indicate ratios with respect to a value at a reference temperature Tmr, namely, normalized values.

The light emitter 5 is formed with a light-emitting element having the same configuration as the light-emitting element forming the image display 2, and the light emitter 5 has the same property as the light-emitting element forming the image display 2. Here, to “have the same property” means that the light emitter 5 is the same as the light-emitting element forming the image display 2 in the temperature change when it is lit up, especially in the relationship between a lighting ratio and the temperature rise.

The light emitter 5 is provided in the vicinity of the image display 2, such as on the back side of the image display 2, namely, the side opposite to a display surface, or on a lateral part of the image display 2.

The control-dedicated temperature measurement module 6 measures the temperature of the light emitter 5 and outputs a temperature measurement value Ta0. The control-dedicated temperature measurement module 6 measures the temperature of the surface of the light emitter 5, for example.

The control-dedicated temperature measurement module 6 includes a temperature sensor. The temperature sensor may be either a contact temperature sensor or a non-contact temperature sensor. The contact temperature sensor can be a temperature sensor formed with a thermistor or a thermocouple, for example. The non-contact temperature sensor can be a sensor that detects the surface temperature by receiving infrared rays.

One temperature is measured if the light emitter 5 is formed with a light-emitting element in which a red LED, a green LED and a blue LED are provided in one package, or three temperatures are measured if the light emitter 5 is formed with a light-emitting element in which a red LED, a green LED and a blue LED are respectively provided in separate packages. When three temperatures are measured, the average value of the three measured temperatures is outputted as the temperature measurement value Ta0 of the light emitter 5. The process of obtaining the average value is executed by the control-dedicated temperature measurement module 6, e.g., in the temperature sensor.

The control-dedicated temperature measurement module 6 may measure an internal temperature of the light emitter 5 instead of measuring the surface temperature of the light emitter 5.

The image processing device 4 makes the image display 2 display an image according to input image data. The image processing device 4 estimates the temperature of each light-emitting element of the image display 2 based on the input image data, makes a correction for compensating for the change in the luminance and the color of the light-emitting element due to the temperature change based on the estimated temperature, and supplies the corrected image data to the image display 2.

The image display 2, the image processing device 4, the light emitter 5 and the control-dedicated temperature measurement module 6 may be respectively provided with separate housings, or two or more of these components may be totally or partially provided with a common housing.

For example, the whole or part, e.g., the temperature sensor, of the control-dedicated temperature measurement module 6 may be formed integrally with the light emitter 5, namely, in the same housing with the light emitter 5.

Part or the whole of the image processing device 4 can be formed of a processing circuitry.

For example, it is possible to either implement functions of the parts of the image processing device individually by separate processing circuitries or implement functions of a plurality of parts collectively by one processing circuitry.

The processing circuitry may be formed with hardware, or software, namely, a programmed computer.

It is also possible to implement part of the functions of the parts of the image processing device by hardware and implement the other part of the functions by software.

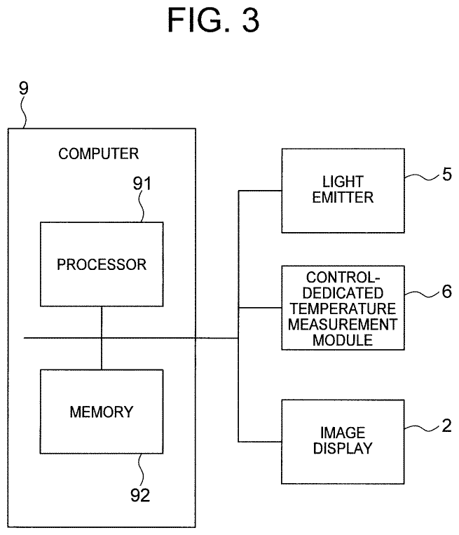

FIG. 3 shows a computer 9 that implements all the functions of the image processing device 4, together with the image display 2, the light emitter 5 and the control-dedicated temperature measurement module 6.

In the illustrated example, the computer 9 includes a processor 91 and a memory 92.

A program for implementing the functions of the parts of the image processing device 4 has been stored in the memory 92.

The processor 91 is a processor employing a Central Processing Unit (CPU), a Graphics Processing Unit (GPU), a microprocessor, a microcontroller, a Digital Signal Processor (DSP) or the like, for example.

The memory 92 is a memory employing a semiconductor memory such as a Random Access Memory (RAM), a Read Only Memory (ROM), a flash memory, an Erasable Programmable Read Only Memory (EPROM) or an Electrically Erasable Programmable Read Only Memory (EEPROM), a magnetic disk, an optical disc, a magneto-optical disk, or the like, for example.

The processor 91 implements the functions of the image processing device by executing the program stored in the memory 92.

The functions of the image processing device include control of display on the image display 2.

While the computer in FIG. 3 includes a single processor, the computer may include two or more processors.

FIG. 1 shows functional blocks constituting the image processing device 4.

The image processing device 4 includes an image input unit 11, a lighting control unit 12, a measured temperature storage unit 13, a temperature estimation unit 14, an estimated temperature storage unit 15, a temperature compensation unit 16 and an image output unit 17.

The following description will be given assuming that the image input unit 11 is a digital interface that receives digital image data Di and outputs the data as input image data Da. However, the image input unit 11 may also be formed of an A/D converter that converts an analog image signal into digital image data.

The image data includes red (R), green (G) and blue (B) pixel values, namely, component values, in regard to each pixel.

The lighting control unit 12 determines the lighting ratio based on the input image data and makes the light emitter 5 light up according to the determined lighting ratio. For example, the lighting control unit 12 calculates an average value of the input image data across one frame period and determines the ratio of the calculated average value to a predetermined reference value as the lighting ratio. More specifically, the lighting control unit 12 obtains average values of the R, G and B component values in regard to all pixels in each image (image of each frame) and determines ratios of the obtained average values to a predetermined reference value as lighting ratios La0r, La0g and La0b of the red, green and blue LEDs forming the light emitter 5.

Namely, the lighting control unit 12 determines the ratio of the average value of the R component values across the whole image to the predetermined reference value as the lighting ratio La0r of the red LED, determines the ratio of the average value of the G component values across the whole image to the predetermined reference value as the lighting ratio La0g of the green LED, and determines the ratio of the average value of the B component values across the whole image to the predetermined reference value as the lighting ratio La0b of the blue LED.

The aforementioned “predetermined reference value” may be, for example, either an upper limit in a range of values that the R, G and B component values can take on or a value as the product of the upper limit and a predetermined coefficient smaller than 1.

The lighting control unit 12 may determine the ratio of the maximum value of each of R, G and B in each image of the input image data to the predetermined reference value as the lighting ratio instead of determining the ratio of the average value of each of R, G and B in each image of the input image data to the predetermined reference value as the lighting ratio as described above.

As described above, the lighting control unit 12 controls the lighting of the light emitter 5 and outputs the calculated lighting ratios La0r, La0g and La0g or an average value of these lighting ratios.

In the following description, it is assumed that the average value is outputted as the lighting ratio La0 of the light emitter 5.

The measured temperature storage unit 13 stores the temperature measurement value Ta0 of the light emitter 5 outputted from the control-dedicated temperature measurement module 6, delays the temperature measurement value Ta0 by one frame period, and outputs the delayed temperature measurement value Ta0 as a temperature measurement value Ta1 one frame earlier.

In contrast to the temperature measurement value Ta1 outputted from the measured temperature storage unit 13, the temperature measurement value Ta0 outputted from the control-dedicated temperature measurement module 6 is the temperature measurement value without the one frame period delay, and thus is referred to as a temperature measurement value in the present frame.

While the measured temperature storage unit 13 has been described to output the temperature measurement value Ta1 delayed by one frame period, the measured temperature storage unit 13 may instead generate and output E temperature measurement values Ta1-TaE (E: natural number greater than or equal to 2) by delaying by one frame period to E frame periods.

The temperature measurement values Ta0-TaE are temperature measurement values acquired in frame periods different from each other, namely, at times different from each other, and thus are collectively referred to as temperature measurement values in a plurality of frames or temperature measurement values at a plurality of times.

Further, the temperature measurement value Ta0 in the present frame can be referred to as a present temperature measurement value, and the temperature measurement values Ta1-TaE one or more frames earlier can be referred to as past temperature measurement values.

The temperature estimation unit 14 successively selects the plurality of light-emitting elements of the image display 2, estimates the temperature of the selected light-emitting element, and outputs a temperature estimate value Te0. The position of each light-emitting element is represented by coordinates (x, y). The temperature estimate value of a light-emitting element at the position (x, y) is represented as Te0(x, y).

Here, x represents a horizontal direction position in the screen and y represents a vertical direction position in the screen. The value x is 1 at a light-emitting element at the left end of the screen, and is xₘₐₓ at a light-emitting element at the right end of the screen. The value y is 1 at a light-emitting element at the upper end of the screen, and is yₘₐₓ at a light-emitting element at the lower end of the screen. Thus, the position of a light-emitting element at the top left corner of the screen is represented as (1, 1), and the position of a light-emitting element at the bottom right corner of the screen is represented as (xₘₐₓ, yₘₐₓ). Each of x and y changes by 1 per pixel pitch (pitch of the light-emitting elements).

The estimated temperature storage unit 15 stores the temperature estimate value Te0(x, y) outputted from the temperature estimation unit 14, delays the temperature estimate value Te0(x, y) by one frame period, and outputs the delayed temperature estimate value Te0(x, y) as a temperature estimate value Te1(x, y) one frame earlier.

In contrast to the temperature estimate value Te1(x, y) outputted from the estimated temperature storage unit 15, the temperature estimate value Te0(x, y) outputted from the temperature estimation unit 14 is the temperature estimate value without the one frame period delay, and thus is referred to as a temperature estimate value in the present frame.

While the estimated temperature storage unit 15 has been described to output the temperature estimate value Te1(x, y) delayed by one frame period, the estimated temperature storage unit 15 may instead generate and output F temperature estimate values Te1(x, y)-TeF(x, y) (F: natural number greater than or equal to 2) by delaying the temperature estimate value Te0(x, y) by one frame period to F frame periods.

The temperature estimate values Te0(x, y)-TeF(x, y) are temperature estimate values obtained by estimation in frame periods different from each other, namely, at times different from each other, and thus are collectively referred to as temperature estimate values in a plurality of frames or temperature estimate values at a plurality of times.

Further, the temperature estimate value Te0 in the present frame can be referred to as a present temperature estimate value, and the temperature estimate values Te1-TeF one or more frames earlier can be referred to as past temperature estimate values.

The temperature estimation unit 14 estimates the temperature of each of the plurality of light-emitting elements forming the image display 2.

Used for the estimation are the input image data Da of the present frame outputted from the image input unit 11, the lighting ratio La0 determined by the lighting control unit 12, the temperature measurement value Ta0 in the present frame outputted from the control-dedicated temperature measurement module 6, the temperature measurement value Ta1 one frame earlier outputted from the measured temperature storage unit 13, and the temperature estimate values Te1 one frame earlier outputted from the estimated temperature storage unit 15.

The temperature estimation unit 14 successively selects the plurality of light-emitting elements forming the image display 2 and estimates the temperature in regard to the selected light-emitting element.

For the estimation of the temperature of the selected light-emitting element, image data regarding light-emitting elements in a vicinal region of the selected light-emitting element are used among the input image data Da, and temperature estimate values regarding light-emitting elements in a vicinal region of the selected light-emitting element are used among the temperature estimate values Te1 one frame earlier.

For example, when the coordinates of the selected light-emitting element are represented as (x, y), a range in which coordinates are represented as (x+α, y+β) (a: any value from −αₘₐₓ to +αₘₐₓ, β: any value from −βₘₐₓ to +βₘₐₓ) is regarded as the vicinal region of the selected light-emitting element. Here, each of αₘₐₓ and βₘₐₓ is a previously set value that is approximately 2 to 10, for example.

In the following description, the coordinates in the aforementioned vicinal region are represented as (x±α, y±β) for convenience.

The values of αₘₐₓ and βₘₐₓ may be either the same as or different from each other.

Incidentally, the vicinal region in regard to the input image data Da and the vicinal region in regard to the temperature estimate value Te1 one frame earlier may differ from each other in the range. Namely, the vicinal region in regard to the input image data Da and the vicinal region in regard to the temperature estimate value Te1 one frame earlier may differ from each other in αₘₐₓ or in βₘₐₓ.

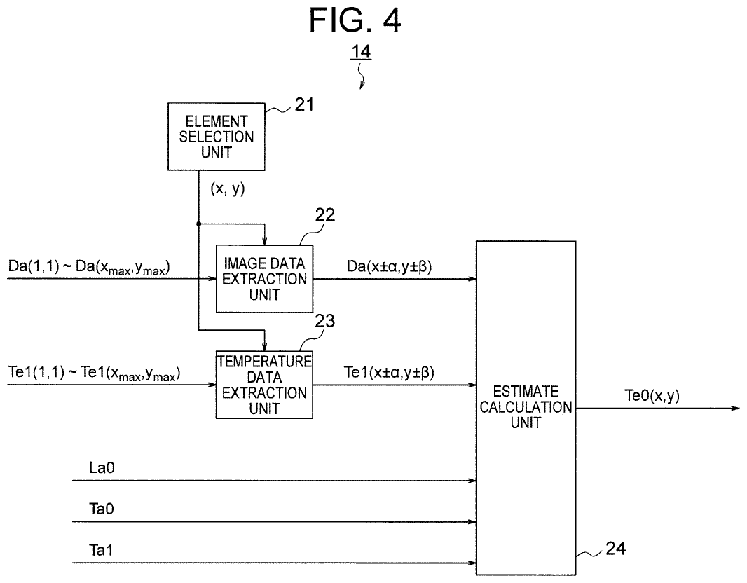

The temperature estimation unit 14 includes an element selection unit 21, an image data extraction unit 22, a temperature data extraction unit 23 and an estimate calculation unit 24 as shown in FIG. 4, for example.

The element selection unit 21 successively selects the light-emitting elements forming the image display 2. For example, the selection is made in order like from the top left corner to the bottom right corner of the screen. Here, the position of the selected light-emitting element is represented as (x, y).

The image data extraction unit 22 extracts image data Da(x±α, y±β) regarding the vicinal region of the selected light-emitting element from the image data Da outputted from the image input unit 11.

For example, in a case where image data (pixel values) regarding all the light-emitting elements forming the image display 2 are successively supplied from the image input unit 11, the image data extraction unit 22 accumulates and outputs the image data regarding the light-emitting elements in the vicinal region of the selected light-emitting element.

In a case where the image data (pixel values) regarding all the light-emitting elements forming the image display 2 are outputted from the image input unit 11 and thereafter temporarily stored in a non-illustrated frame buffer, the image data extraction unit 22 reads out the image data regarding the light-emitting elements in the vicinal region of the selected light-emitting element from the frame buffer.

The temperature data extraction unit 23 extracts temperature estimate values Te1(x±α, y±β) regarding the light-emitting elements in the vicinal region of the selected light-emitting element from the temperature estimate values Te1 one frame earlier stored in the estimated temperature storage unit 15. For example, the temperature data extraction unit 23 selects and outputs the temperature estimate values regarding the light-emitting elements in the vicinal region of the selected light-emitting element out of the temperature estimate values regarding all the light-emitting elements stored in the estimated temperature storage unit 15.

The estimate calculation unit 24 obtains the temperature estimate value Te0(x, y) of the selected light-emitting element based on the image data Da(x±α, y±β) extracted by the image data extraction unit 22, the temperature estimate values Te1(x±α, y±β) extracted by the temperature data extraction unit 23, the lighting ratio La0 determined by the lighting control unit 12, the temperature measurement value Ta0 in the present frame outputted from the control-dedicated temperature measurement module 6, and the temperature measurement value Ta1 one frame earlier outputted from the measured temperature storage unit 13.

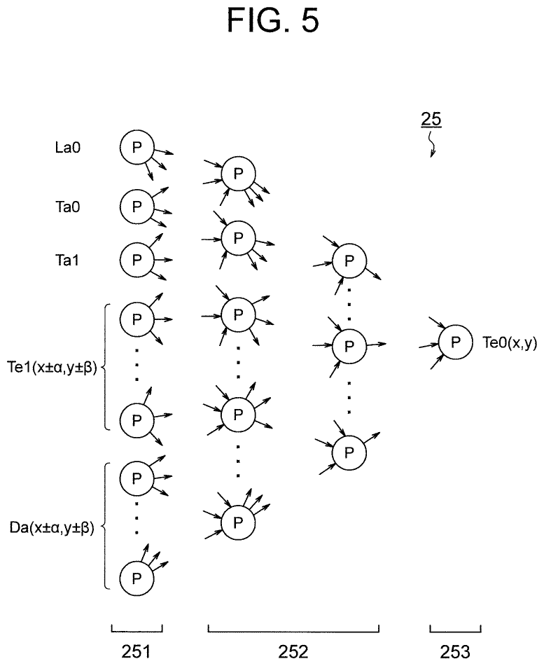

The estimate calculation unit 24 is formed with a multi-layer neural network. FIG. 5 shows an example of such a multi-layer neural network 25.

The neural network 25 shown in FIG. 5 includes an input layer 251, intermediate layers (hidden layers) 252 and an output layer 253. While the number of intermediate layers is two in the illustrated example, the number of intermediate layers can also be one, or three or more.

Each neuron P in the input layer 251 is assigned one of the lighting ratio La0, the temperature measurement values Ta0, Ta1 at a plurality of times, the past temperature estimate values Te1(x±α, y±β), namely, the temperature estimate values respectively regarding a plurality of light-emitting elements, and the input image data Da(x±α, y±β), namely, the image data (pixel values) respectively regarding a plurality of light-emitting elements, and the assigned value (lighting ratio, temperature measurement value, temperature estimate value or input image data) is inputted to each neuron. Each neuron in the input layer 251 outputs the input without change.

The neuron P in the output layer 253 is formed of a plurality of bits such as 10 bits, for example, and outputs data indicating the temperature estimate value Te0(x, y) of the selected light-emitting element.

Each neuron P in the intermediate layer 252 or the output layer 253 performs calculation indicated by the following model formula on a plurality of inputs:

y=s(w₁×x₁+w₂×x₂+ . . . +w_{N}×x_{N}+b) expression (1)

In the expression (1), N represents the number of inputs to the neuron P, which is not necessarily the same as each other between neurons. The characters x₁-x_{N} represent the input data to the neuron P, w₁-w_{N} represent weights on the inputs x₁-x_{N}, and b represents a bias.

The weights and the bias have been determined by means of learning.

In the following description, the weights and the bias will be collectively referred to as parameters.

The function s(a) is an activating function.

The activating function can be, for example, the step function that outputs 0 if “a” is less than or equal to 0 or outputs 1 otherwise.

The activating function s(a) can also be the ReLU function that outputs 0 if “a” is less than or equal to 0 or outputs the input value “a” otherwise, the identity function that outputs the input value “a” without change as the output value, or the sigmoid function.

Since each neuron in the input layer 251 outputs the input without change as mentioned above, the activating function used by the neuron in the input layer 251 can be regarded as the identity function.

It is possible, for example, to use the step function or the sigmoid function in the intermediate layer 252 and use the ReLU function in the output layer. It is permissible even if neurons in the same layer use activating functions different from each other.

The number of neurons P and the number of layers (step number) are not limited to the example shown in FIG. 5.

The temperature compensation unit 16 corrects the image data supplied from the image input unit 11 based on the temperatures Te0(x, y) estimated by the temperature estimation unit 14.

This correction is made in regard to each pixel.

This correction is a correction for canceling out the changes in the luminance and the chromaticity due to the temperature change of the light-emitting element, and is made for compensating for the changes in the luminance and the chromaticity.

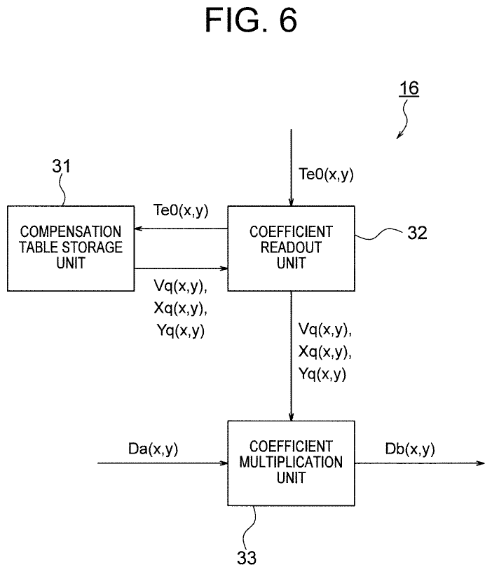

The temperature compensation unit 16 includes a compensation table storage unit 31, a coefficient readout unit 32 and a coefficient multiplication unit 33 as shown in FIG. 6, for example.

The compensation table storage unit 31 has stored a compensation table for compensating for the changes in the luminance and the chromaticity due to the temperature.

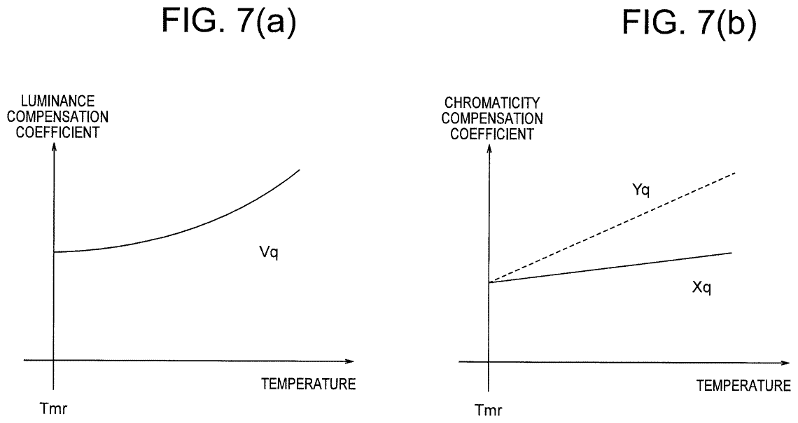

FIGS. 7(a) and 7(b) show an example of the relationship between an input and an output defined by the compensation table stored in the compensation table storage unit 31. The relationship between an input and an output mentioned here means the ratio of the output to the input, which is represented by a coefficient. This coefficient is referred to as a compensation coefficient.

For example, in the case where the change in the luminance due to the temperature is as shown in FIG. 2(a), the stored compensation table regarding the luminance is a compensation table having the input-output relationship illustrated in FIG. 7(a), namely, a compensation table in which the change due to the temperature rise is in the direction opposite to that in FIG. 2(a).

For example, the compensation table is formed with compensation coefficients Vg each of which is equal to the inverse number of a normalized value of the luminance Vp.

Similarly, in the case where the changes in the X stimulus value and the Y stimulus value representing the chromaticity due to the temperature are as shown in FIG. 2(b), the stored compensation table is a compensation table having the input-output relationship illustrated in FIG. 7(b), namely, a compensation table in which the change due to the temperature rise is in the direction opposite to that in FIG. 2(b).

For example, the compensation table regarding the X stimulus value is formed with compensation coefficients Xq each of which is equal to the inverse number of a normalized value of the X stimulus value Xp. Similarly, the compensation table regarding the Y stimulus value is formed with compensation coefficients Yq each of which is equal to the inverse number of a normalized value of the Y stimulus value Yp.

The coefficient readout unit 32 reads out the compensation coefficients Vq(x, y), Xq(x, y) and Yq(x, y) corresponding to the temperature estimate value Te0(x, y) of each light-emitting element by referring to the compensation tables stored in the compensation table storage unit 31 by using the temperature estimate value Te0(x, y) of the light-emitting element and supplies the coefficient multiplication unit 33 with the compensation coefficients that have been read out.

The coefficient multiplication unit 33 makes a correction by multiplying the input image data Da(x, y) by the compensation coefficients Vq(x, y), Xq(x, y) and Yq(x, y) that have been read out, and thereby generates and outputs corrected image data Db(x, y), namely, compensated image data Db(x, y) corresponding to the input image data Da(x, y).

For example, in the case where the input image data Da is formed of the R, G and B component values, the corrected image data Db is generated by converting the R, G and B component values into luminance components and chromaticity components in regard to each pixel, correcting the luminance components by using the luminance compensation table, correcting the chromaticity components by using the chromaticity compensation table, and reversely converting the corrected luminance components and chromaticity components into R, G and B component values.

Incidentally, the compensation table storage unit 31 may hold compensation tables formed with compensation coefficients for respectively correcting the R, G and B component values instead of storing the compensation tables formed with compensation coefficients for correcting the luminance and the chromaticity as described above.

There is a case where the light-emitting elements differ from each other in the manners of the changes in the luminance and the chromaticity due to the temperature. In such case, curved lines indicating average changes are used as the curved lines representing the luminance and the chromaticity in FIGS. 2(a) and 2(b). For example, values as the averages of changes in regard to a great number of light-emitting elements are used, and compensation tables for compensating for such average changes are generated as the compensation tables representing the compensation coefficients shown in FIGS. 7(a) and 7(b).

It is also possible to use compensation tables that vary from light-emitting element to light-emitting element instead of using the compensation tables for compensating for the average changes in regard to a great number of light-emitting elements as described above. Further, it is also possible to use different compensation tables for each of the R, G and B LEDs.

While the compensation table has been assumed to have a value of the compensation coefficient for each of values that the temperature estimate value Te0 of the light-emitting element can take on, the compensation table is not limited to this example. Specifically, the compensation table may discretely have a value of the compensation coefficient for the temperature estimate value Te0 of the light-emitting element, and for temperature estimate values Te0 of the light-emitting element having no value of the compensation coefficient, the corresponding values of the compensation coefficient may be obtained by interpolation. This interpolation can be carried out by using values of the compensation coefficient corresponding to temperature estimate values Te0 having the values of the compensation coefficient (table points), for example.

The image output unit 17 converts the image data Db outputted from the temperature compensation unit 16 into a signal in a format in conformity with the display method of the image display 2 and outputs the image signal Do after the conversion.

In a case where the light-emitting elements of the image display 2 are made to emit light by Pulse Width Modulation (PWM) driving, gradation values of the image data are converted into a PWM signal.

The image display 2 displays an image based on the image signal Do. The displayed image is an image in which the changes in the luminance and the color due to the temperature have been compensated for in regard to each pixel. Accordingly, an image with no luminance irregularity or color irregularity is displayed.

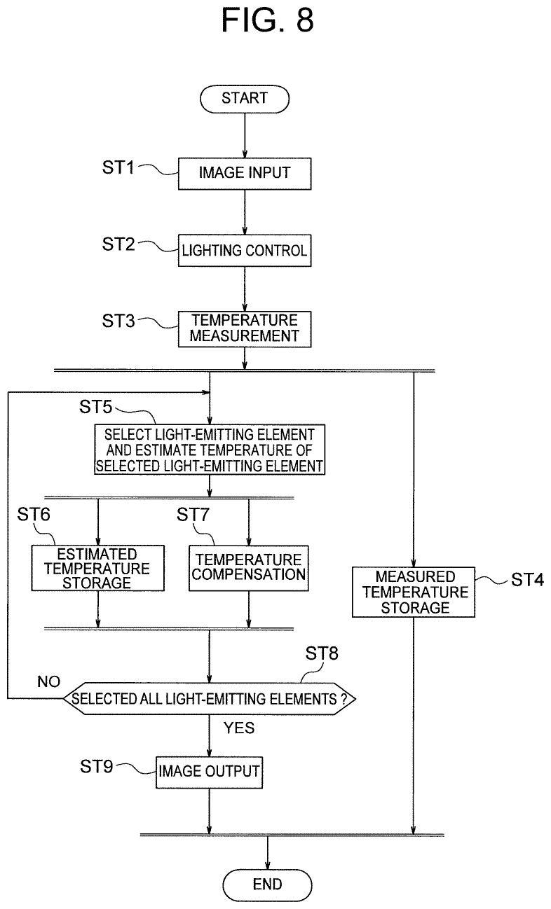

A procedure of a process executed by the processor 91 in the case where the above-described image processing device 4 is formed with the computer shown in FIG. 3 will be described below with reference to FIG. 8.

The process of FIG. 8 is executed for each frame period.

In step ST1, the inputting of an image is executed. This process is the same as the process by the image input unit 11 in FIG. 1.

In step ST2, the calculation of the lighting ratio and the control of the lighting of the light emitter 5 are executed. This process is the same as the process by the lighting control unit 12 in FIG. 1.

In step ST3, the acquisition of the temperature measurement value of the light emitter 5 is executed. This process is the same as the process by the control-dedicated temperature measurement module 6 in FIG. 1.

In step ST4, the storing of the temperature measurement value is executed. This process is the same as the process by the measured temperature storage unit 13 in FIG. 1.

In step ST5, one of the plurality of light-emitting elements forming the image display 2 is selected and the estimation of the temperature of the selected light-emitting element is executed. This process is the same as the process by the temperature estimation unit 14 in FIG. 1.

In step ST6, the storing of the temperature estimate value is executed. This process is the same as the process by the estimated temperature storage unit 15 in FIG. 1.

In step ST7, the temperature compensation is executed in regard to the selected light-emitting element. This process is the same as the process by the temperature compensation unit 16 in FIG. 1.

In step ST8, it is judged whether or not all of the light-emitting elements forming the image display 2 have been selected.

If not all have been selected, the process returns to the step ST5. If all have been selected, the process advances to step ST9.

In the step ST9, the image output is executed. This process is the same as the process by the image output unit 17 in FIG. 1.

The temperature measurement value stored in the step ST4 and the temperature estimate value stored in the step ST6 will be used in the process of the step ST5 in the next frame period.

The neural network 25 shown in FIG. 5 is generated by means of machine learning.

A learning device for the machine learning is connected to the image display device of FIG. 1 and used.

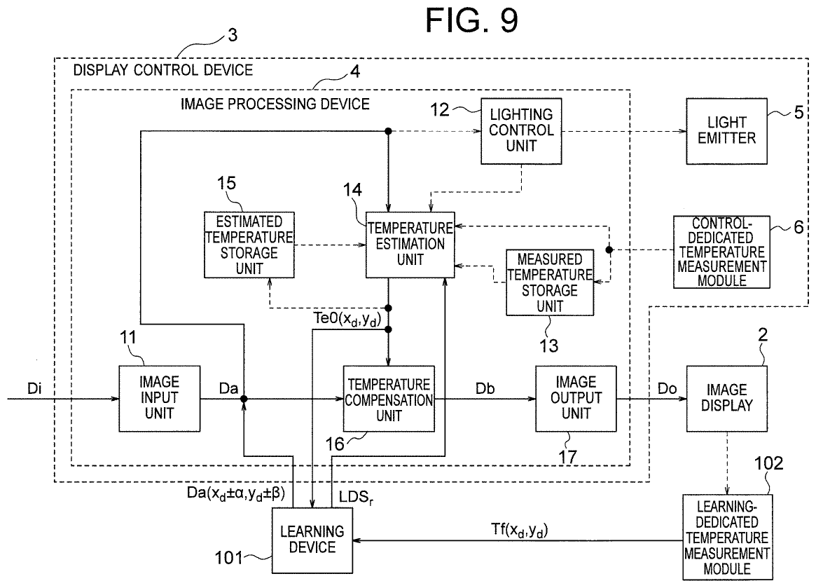

FIG. 9 shows the learning device 101 connected to the image display device of FIG. 1. FIG. 9 also shows a learning-dedicated temperature measurement module 102 used together with the learning device 101.

The learning-dedicated temperature measurement module 102 includes one or more temperature sensors. The one or more temperature sensors are provided respectively corresponding to one or more light-emitting elements among the light-emitting elements forming the image display 2, and each temperature sensor measures the temperature of the corresponding light-emitting element and thereby obtains the measured temperatures Tf(1), Tf(2), . . . .

Each of the temperature sensors may have the same configuration as the temperature sensor forming the control-dedicated temperature measurement module 6.

The whole or part of the learning-dedicated temperature measurement module 102, e.g., the temperature sensors, may be formed integrally with the image display 2, namely, in the same housing with the image display 2.

One or more light-emitting elements as the targets of the temperature measurement are designated previously. When one light-emitting element is designated, it is possible, for example, to designate a light-emitting element situated at the center of the screen or to designate a light-emitting element situated between the center and a peripheral part of the screen. When two or more light-emitting elements are designated, it is possible, for example, to designate two or more light-emitting elements situated at positions on the screen separate from each other. For example, it is possible to designate a light-emitting element situated at the center of the screen and one or more light-emitting elements situated in the peripheral part of the screen.

The light-emitting elements that have been designated are referred to as designated light-emitting elements.

When the temperatures of two or more designated light-emitting elements are measured, the average value of the measured temperatures Tf(1), Tf(2), . . . may be outputted as a temperature measurement value Tf.

In the following description, the number of designated light-emitting elements is assumed to be 1, the position of the designated light-emitting element is represented as (x_{d}, y_{d}), and the temperature measurement value of the designated light-emitting element is represented as Tf(x_{d}, y_{d}).

The learning device 101 may be foamed with a computer. In the case where the image processing device 4 is formed with a computer, the learning device 101 may be foamed with the same computer. The computer forming the learning device 101 may be the computer shown in FIG. 3, for example. In that case, the function of the learning device 101 may be implemented by the processor 91 by executing a program stored in the memory 92.

The learning device 101 makes a part of the image processing device 4 operate, makes the temperature estimation unit 14 estimate the temperature of the aforementioned designated light-emitting element, and executes the learning so that the temperature estimate value Te0(x_{d}, y_{d}) becomes close to the temperature measurement value Tf(x_{d}, y_{d}) of the designated light-emitting element obtained by the measurement by the learning-dedicated temperature measurement module 102.

For the learning, a plurality of sets LDS of learning input data are used.

Each of the learning input data sets LDS includes input image data Da, a lighting ratio La0, a temperature measurement value Ta0 in the present frame, a temperature measurement value Ta1 one frame earlier and temperature estimate values Te1 one frame earlier that have been prepared for the learning.

As the input image data Da, image data Da(x_{d}±α, y_{d}±β) regarding the light-emitting elements in a vicinal region (x_{d}±α, y_{d}±β) of the designated light-emitting element is used.

As the temperature estimate values Te1 one frame earlier, temperature estimate values Te1(x_{d}±α, y_{d}±β) regarding the light-emitting elements in the vicinal region (x_{d}±α, y_{d}±β) of the designated light-emitting element are used.

Between the plurality of learning input data sets LDS, at least one of the input image data Da(x_{d}±α, y_{d}±β), the lighting ratio La0, the temperature measurement value Ta0 in the present frame, the temperature measurement value Ta1 one frame earlier and the temperature estimate values Te1(x_{d}±α, y_{d}±β) one frame earlier differs from each other.

The learning device 101 successively selects the plurality of learning input data sets LDS previously prepared, inputs the selected learning input data set LDS to the image processing device 4, acquires the temperature estimate value Te0(x_{d}, y_{d}) calculated by the temperature estimation unit 14 and the temperature measurement value Tf(x_{d}, y_{d}) obtained by the measurement by the learning-dedicated temperature measurement module 102, and executes the learning so that the temperature estimate value Te0(x_{d}, y_{d}) becomes close to the temperature measurement value Tf(x_{d}, y_{d}).

To “input the selected learning input data set LDS to the image processing device 4” means to input the image data Da(x_{d}±α, y_{d}±β) included in the selected learning input data set LDS to the lighting control unit 12, the temperature estimation unit 14 and the temperature compensation unit 16 and input the lighting ratio La0, the temperature measurement value Ta0 in the present frame, the temperature measurement value Ta1 one frame earlier and the temperature estimate values Te1(x_{d}±α, y_{d}±β) one frame earlier included in the selected learning input data set LDS to the temperature estimation unit 14.

In FIG. 9, data in the learning input data set LDS other than the image data Da(x_{d}±α, y_{d}±β) are represented by the reference character LDSᵣ. The same goes for other subsequent drawings.

In the generation of the neural network by the learning device 101, a neural network as the base is prepared first.

Namely, the estimate calculation unit 24 in the temperature estimation unit 14 is provisionally constructed with the neural network as the base. While this neural network is a neural network similar to the neural network shown in FIG. 5, each of the neurons in the intermediate layer or the output layer is connected to all the neurons in the layer in front.

In the generation of the neural network, it is necessary to set the values of the parameters (the weights and the bias) for each of the plurality of neurons. A set of parameters regarding the plurality of neurons is referred to as a parameter set and is represented by a reference character PS.

In the generation of the neural network, optimization of the parameter set PS is executed by using the aforementioned neural network as the base so that the difference of the temperature estimate value Te0(x_{d}, y_{d}) from the temperature measurement value Tf(x_{d}, y_{d}) becomes less than or equal to a predetermined threshold value. The optimization can be executed by the error back propagation method, for example.

Specifically, the learning device 101 prepares a plurality of learning input data sets LDS, sets initial values of the parameter set PS, and successively selects the plurality of learning input data sets LDS.

The learning device 101 inputs the selected learning input data set LDS to the image processing device 4 and obtains the difference (Te0(x_{d}, y_{d})-Tf(x_{d}, y_{d})) between the temperature measurement value Tf(x_{d}, y_{d}) and the temperature estimate value Te0(x_{d}, y_{d}) of the designated light-emitting element as an error ER.

The learning device 101 obtains a sum total ES of the aforementioned errors ER regarding the plurality of learning data sets LDS as a cost function, and if the cost function is greater than a threshold value, changes the parameter set PS so that the cost function becomes smaller.

The learning device 101 repeats the above-described process until the cost function becomes less than or equal to the threshold value. The changing of the parameter set PS can be executed by the gradient descent method.

As the sum total ES of the errors ER, the sum of the absolute values of the errors ER or the sum of the squares of the errors ER can be used.

In the learning, it is unnecessary to make the light emitter 5 emit light, and thus the lighting control unit 12, the control-dedicated temperature measurement module 6 and the measured temperature storage unit 13 do not need to operate. Further, the estimated temperature storage unit 15 does not need to operate either. To indicate these conditions, signal lines for transmitting inputs to these components and outputs from these components are indicated by dotted lines in FIG. 9. Further, a dotted line in FIG. 1 indicating the measurement of the temperature of the light emitter 5 by the control-dedicated temperature measurement module 6 is deleted.

The image data Da(x_{d}±α, y_{d}±β) inputted to the temperature compensation unit 16 is supplied to the image display 2 via the image output unit 17 and used for driving light-emitting elements of the image display 2.

Light-emitting elements outside the vicinal region of the designated light-emitting element may be either driven or not driven. When the light-emitting elements outside the vicinal region are driven, the light-emitting elements outside the vicinal region may be driven by using an arbitrary signal.

The temperature estimate value Te0(x_{d}, y_{d}) obtained by the estimation by the temperature estimation unit 14 is inputted to the learning device 101, in which the learning is executed so that the temperature estimate value Te0(x_{d}, y_{d}) becomes close to the temperature measurement value Tf(x_{d}, y_{d}).

After the optimization of the parameter set PS, the learning device 101 disconnects synaptic connections (connections between neurons) whose weights have become zero.

After the learning is over, the temperature sensors of the learning-dedicated temperature measurement module 102 are detached and the image display device is used in the state in which those temperature sensors have been detached.

Namely, when used for displaying images, the image display device does not need the temperature sensors for detecting the temperatures of the light-emitting elements. This is because the temperatures of the light-emitting elements can be estimated by the temperature estimation unit 14 even without the temperature sensors for detecting the temperatures of the light-emitting elements.

After the learning is over, the learning device 101 may be either detached or left attached.

Especially in a case where the function of the learning device 101 is implemented by the execution of a program by the processor 91, the program may be left stored in the memory 92.

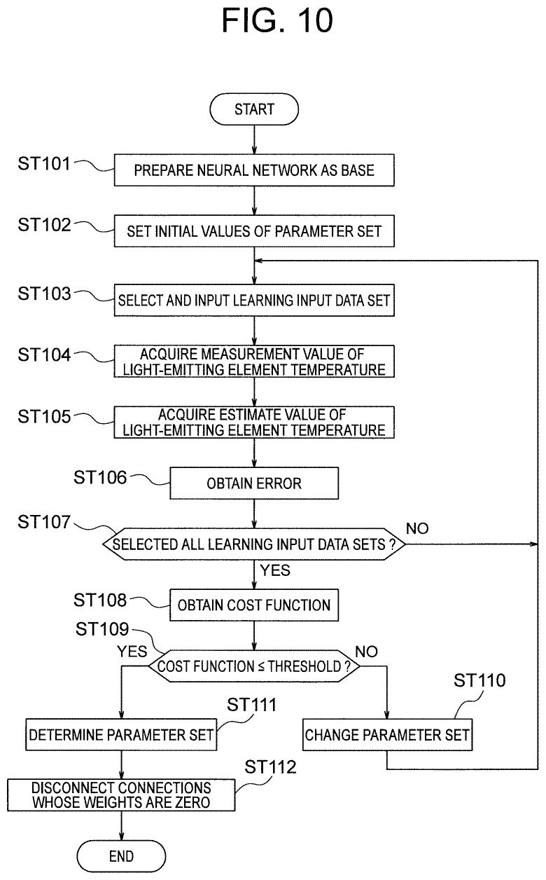

A procedure of a process executed by the processor 91 in the case where the above-described learning device 101 is formed with the computer shown in FIG. 3 will be described below with reference to FIG. 10.

In step ST101 in FIG. 10, the learning device 101 prepares the neural network as the base. Namely, the estimate calculation unit 24 in the temperature estimation unit 14 is provisionally constructed with the neural network as the base.

While this neural network is a neural network similar to that shown in FIG. 5, each of the neurons in the intermediate layer or the output layer is connected to all the neurons in the layer in front.

In step ST102, the learning device 101 sets the initial values of the set PS of parameters (weights and biases) used in the calculations in the neurons in the intermediate layer or the output layer of the neural network prepared in the step ST101.

The initial values may be either values randomly selected or values expected to be appropriate.

In step ST103, the learning device 101 selects one learning input data set LDS from the plurality of learning input data sets LDS previously prepared, and inputs the selected learning input data set to the image processing device 4.

To “input the selected learning input data set to the image processing device 4” means to input the image data Da(x±α, y±β) included in the selected learning input data set LDS to the lighting control unit 12, the temperature estimation unit 14 and the temperature compensation unit 16 and input the lighting ratio La0, the temperature measurement value Ta0 in the present frame, the temperature measurement value Ta1 one frame earlier and the temperature estimate values Te1(x±α, y±β) one frame earlier included in the selected learning input data set LDS to the temperature estimation unit 14.

The image data Da(x_{d}±α, y_{d}±β) inputted to the temperature compensation unit 16 is supplied to the image display 2 via the image output unit 17 and used for driving light-emitting elements of the image display 2.

In step ST104, the learning device 101 acquires the temperature measurement value Tf(x_{d}, y_{d}) of the designated light-emitting element.

The temperature measurement value Tf(x_{d}, y_{d}) acquired here is the temperature measurement value at the time when the image display 2 displayed an image according to the image data Da(x_{d}±α, y_{d}±β) included in the selected learning input data set LDS.

In step ST105, the learning device 101 acquires the temperature estimate value Te0(x_{d}, y_{d}) of the designated light-emitting element.

The temperature estimate value Te0(x_{d}, y_{d}) acquired here is the temperature estimate value calculated by the temperature estimation unit 14 based on the image data Da(x_{d}±α, y_{d}±β), the lighting ratio La0, the temperature measurement value Ta0 in the present frame, the temperature measurement value Ta1 one frame earlier and the temperature estimate values Te1(x_{d}±α, y_{d}±β) one frame earlier included in the selected learning input data set LDS and by using the currently set parameter set PS.

The currently set parameter set PS is the set of parameters provisionally set to the neural network forming the estimate calculation unit 24 in the temperature estimation unit 14.

In step ST106, the learning device 101 obtains the difference between the temperature measurement value Tf(x_{d}, y_{d}) acquired in the step ST104 and the temperature estimate value Te0(x_{d}, y_{d}) acquired in step ST105 as the error ER.

In step ST107, the learning device 101 judges whether or not the processing of the steps ST103 to ST106 has been finished for all of the plurality of learning input data sets.

If the aforementioned processing has not been finished for all of the plurality of learning input data sets, the process returns to the step ST103.

Consequently, the next learning input data set LDS is selected in the step ST103 and the same process is repeated and the error ER is obtained for the selected learning input data set LDS in the steps ST104 to ST106.

If the aforementioned processing has been finished for all of the plurality of learning input data sets in the step ST107, the process advances to step ST108.

In the step ST108, the learning device 101 obtains the sum total (sum total regarding the plurality of learning input data sets LDS) ES of the aforementioned errors ER as the cost function.

As the sum total ES of the errors ER, the sum of the absolute values of the errors ER or the sum of the squares of the errors ER can be used.

Subsequently, in step ST109, the learning device 101 judges whether or not the cost function is less than or equal to a predetermined threshold value.

If the cost function is greater than the threshold value in the step ST109, the process advances to step ST110.

In the step ST110, the learning device 101 changes the parameter set PS. The changing is made so that the cost function becomes smaller. The gradient descent method can be used for the changing.

After the changing, the process returns to the step ST103.

If the cost function is less than or equal to the threshold value in the step ST109, the process advances to step ST111.

In the step ST111, the learning device 101 employs the currently set parameter set PS, namely, the parameter set PS that was used for the calculation of the temperature estimate value in the immediately previous step ST105, as an optimum parameter set.

In step ST112, synaptic connections whose weights, included in the employed parameter set PS, have become zero are disconnected.

The process of generating the neural network is finished as above.

Namely, the estimate calculation unit 24 of the temperature estimation unit 14 is constructed as a unit formed with the neural network generated by the above-described process.

By executing the disconnection of the connections in the above step ST112, the configuration of the neural network is simplified and the calculation for the temperature estimation at the time of displaying an image becomes simpler.

As described above, according to the first embodiment, the temperature of each light-emitting element can be estimated based on the input image data, and thus the changes in the luminance and the color of each light-emitting element due the temperature change can be compensated for even if the image display device does not include the temperature sensors for measuring the temperatures of the light-emitting elements.

Incidentally, while the temperature sensors of the learning-dedicated temperature measurement module 102 are detached after the learning is over in the above-described example, the temperature sensors of the learning-dedicated temperature measurement module 102 may be left attached after the learning is over. Even in that case, advantages are obtained in that the image display device does not need to include temperature sensors for measuring the temperatures of light-emitting elements other than the designated light-emitting element, and at the time of displaying an image, the changes in the luminance and the color of each light-emitting element due the temperature change can be compensated for even without the need of measuring the temperature of the designated light-emitting element.

### Second Embodiment

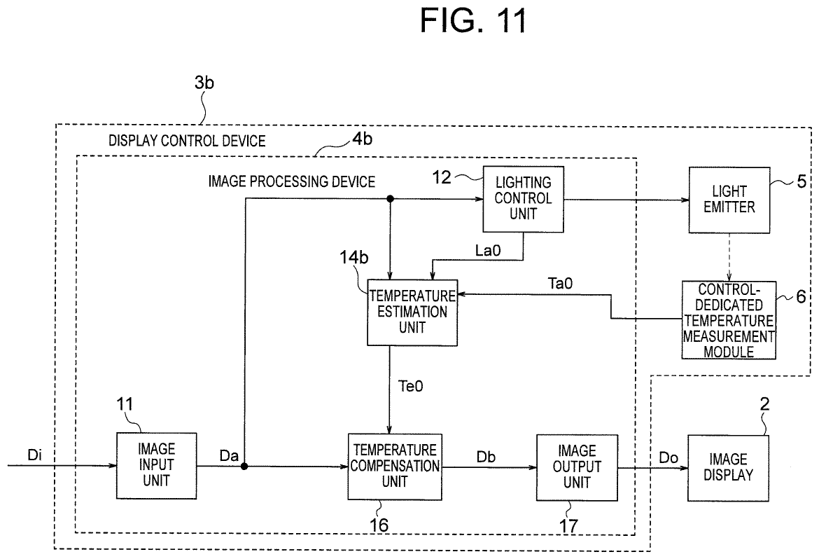

FIG. 11 shows the configuration of an image display device in a second embodiment of the present invention. The image display device shown in FIG. 11 includes a display control device 3b. The display control device 3b is roughly the same as the display control device 3 shown in FIG. 1. However, an image processing device 4b is provided instead of the image processing device 4. The image processing device 4b is roughly the same as the image processing device 4 shown in FIG. 1. However, the measured temperature storage unit 13 and the estimated temperature storage unit 15 shown in FIG. 1 are not provided and a temperature estimation unit 14b is provided instead of the temperature estimation unit 14 shown in FIG. 1.

As described earlier, the temperature estimation unit 14 in the first embodiment estimates the temperature of each light-emitting element of the image display 2 based on the input image data Da, the lighting ratio La0, the temperature measurement values Ta0, Ta1 of the light emitter 5 at a plurality of times and the past temperature estimate values Te1. In contrast, the temperature estimation unit 14b in the second embodiment estimates the temperature of each light-emitting element of the image display 2 by using the input image data Da, the lighting ratio La0 and the present temperature measurement value Ta0 of the light emitter 5, without using the past temperature measurement value Ta1 and the past temperature estimate values Te1.

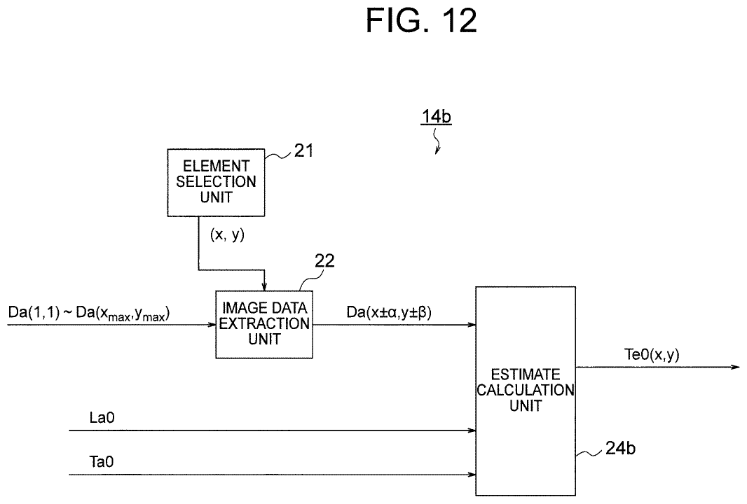

The temperature estimation unit 14b is configured as shown in FIG. 12, for example. The temperature estimation unit 14b shown in FIG. 12 is roughly the same as the temperature estimation unit 14 shown in FIG. 4. However, the temperature data extraction unit 23 shown in FIG. 4 is not provided and an estimate calculation unit 24b is provided instead of the estimate calculation unit 24.

The estimate calculation unit 24b obtains the temperature estimate value Te0(x, y) of the selected light-emitting element based on the image data Da(x±α, y±β) extracted by the image data extraction unit 22, the lighting ratio La0 determined by the lighting control unit 12, and the temperature measurement value Ta0 in the present frame outputted from the control-dedicated temperature measurement module 6.

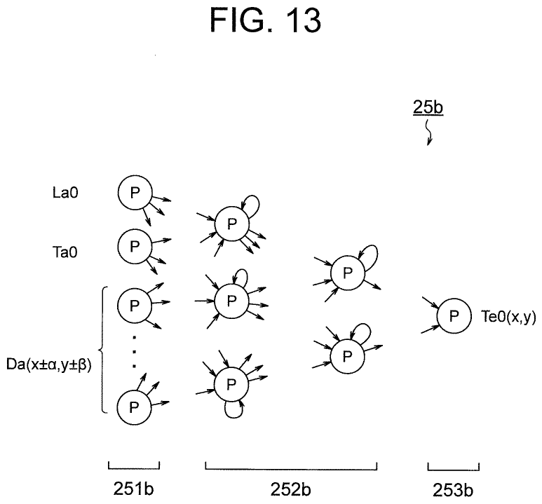

The estimate calculation unit 24b is formed with a multi-layer neural network. FIG. 13 shows an example of such a multi-layer neural network 25b.

The neural network 25b of FIG. 13 is roughly the same as the neural network 25 of FIG. 5 and includes an input layer 251b, intermediate layers (hidden layers) 252b and an output layer 253b. While the number of intermediate layers is two in the illustrated example, the number of intermediate layers can also be one, or three or more.

The input layer 251b is roughly the same as the input layer 251 of the neural network 25 of FIG. 5. However, to the input layer 251b of the neural network 25b of FIG. 13, the temperature estimate values Te1(x±α, y±β) and the temperature measurement value Ta1 are not inputted, and the input image data Da(x±α, y±β), the lighting ratio La0 and the temperature measurement value Ta0 are inputted.

The neuron in the output layer 253b is formed of a plurality of bits such as 10 bits, for example, and outputs data indicating the temperature estimate value Te0(x, y) of the light-emitting element similarly to the neuron in the output layer 253 shown in FIG. 5.

As each of at least part of the neurons in the intermediate layer 252b, a neuron having a synaptic connection for feedback is used.

Each neuron P having the synaptic connection for feedback performs calculation indicated by the following model formula on a plurality of inputs:

y=s(w₀^{x}y₍ₜ₋₁₎+w₁×x₁+w₂×x₂+ . . . +w_{N}×x_{N}+b) expression (2)

In the expression (2), w₀ represents the weight on the output y₍ₜ₋₁₎ of the same neuron one time step earlier.

Except for the addition of the term w₀×y₍ₜ₋₁₎, the expression (2) is the same as the expression (1).

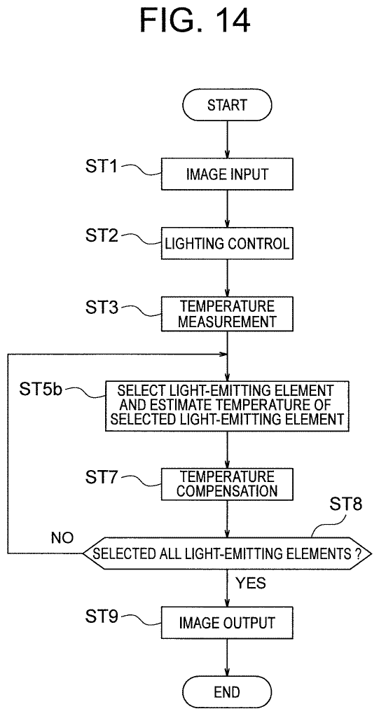

A procedure of a process executed by the processor 91 in the case where the above-described image processing device 4b is formed with the computer shown in FIG. 3 will be described below with reference to FIG. 14.

The procedure of the process of FIG. 14 is roughly the same as the procedure of the process of FIG. 8. However, the steps ST4 and ST6 in FIG. 8 are not included. Further, the step ST5 in FIG. 8 is replaced with step ST5b.

In the step ST5b, the estimation of the temperature of each light-emitting element is executed. This process is the same as the process by the temperature estimation unit 14b in FIG. 11.

The neural network forming the temperature estimation unit 14b, that is, the neural network shown in FIG. 13, is also generated by means of machine learning. The method of the machine learning is similar to that described in the first embodiment. However, in each neuron in the intermediate layer 252b, every one of its outputs and inputs has a synaptic connection at the beginning, and the synaptic connection is disconnected when the weight becomes zero as the result of the learning.

Also with the second embodiment, advantages the same as those of the first embodiment are obtained. In addition, an advantage is obtained in that the configuration is simple since the measured temperature storage unit 13 and the estimated temperature storage unit 15 used in the first embodiment are unnecessary.

### Third Embodiment

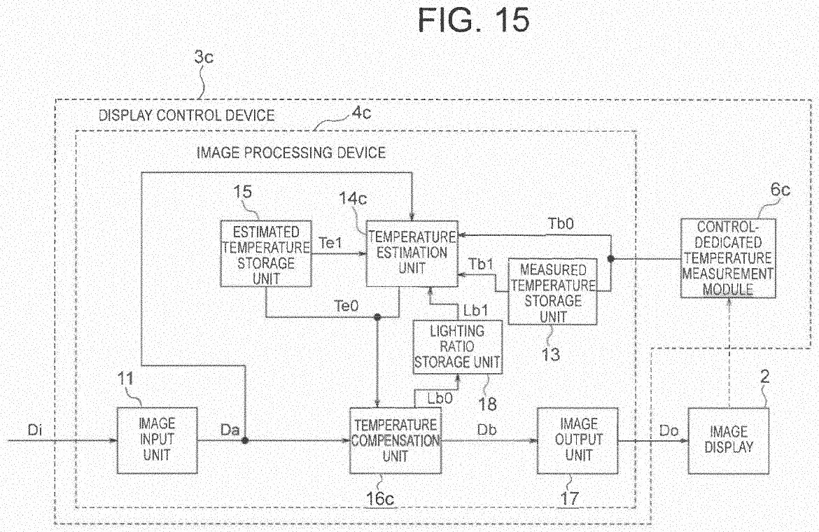

FIG. 15 shows the configuration of an image display device in a third embodiment of the present invention. The image display device shown in FIG. 15 includes a display control device 3c. The display control device 3c is roughly the same as the display control device 3 shown in FIG. 1. However, the light emitter 5 is not provided and an image processing device 4c and a control-dedicated temperature measurement module 6c are provided instead of the image processing device 4 and the control-dedicated temperature measurement module 6.

The image processing device 4c is roughly the same as the image processing device 4 shown in FIG. 1. However, a temperature estimation unit 14c and a temperature compensation unit 16c are provided instead of the temperature estimation unit 14 and the temperature compensation unit 16, and a lighting ratio storage unit 18 is further added.

The control-dedicated temperature measurement module 6c includes one temperature sensor. The one temperature sensor measures the temperature of one previously selected light-emitting element (selected light-emitting element) among the light-emitting elements forming the image display 2 and outputs a temperature measurement value Tb0.

The temperature sensor forming the control-dedicated temperature measurement module 6c may have the same configuration as the temperature sensor forming the control-dedicated temperature measurement module 6. Namely, the temperature sensor may be either a contact temperature sensor or a non-contact temperature sensor. The contact temperature sensor can be a temperature sensor formed with a thermistor or a thermocouple, for example. The non-contact temperature sensor can be a sensor that detects the surface temperature by receiving infrared rays.

One temperature is measured if the selected light-emitting element is a light-emitting element in which three LEDs: a red LED, a green LED and a blue LED are provided in one package, or three temperatures are measured if the selected light-emitting element is formed of a light-emitting element in which a red LED, a green LED and a blue LED are respectively provided in separate packages. When three temperatures are measured, the average value of the three measured temperatures is outputted as the temperature measurement value Tb0 of the selected light-emitting element. The process of obtaining the average value is executed by the control-dedicated temperature measurement module 6c, e.g., in the temperature sensor.

The control-dedicated temperature measurement module 6c may measure an internal temperature of the light-emitting element instead of measuring the surface temperature of the light-emitting element.

The whole or part, e.g., the temperature sensor, of the control-dedicated temperature measurement module 6c may be formed integrally with the image display 2, namely, in the same housing with the image display 2.

The measured temperature storage unit 13 stores the temperature measurement value Tb0 of the selected light-emitting element of the image display 2 outputted from the control-dedicated temperature measurement module 6c, delays the temperature measurement value Tb0 by one frame period, and outputs the delayed temperature measurement value Tb0 as a temperature measurement value Tb1 one frame earlier.

While the measured temperature storage unit 13 has been described to output the temperature measurement value Tb1 delayed by one frame period, the measured temperature storage unit 13 may instead generate and output G temperature measurement values Tb1-TbG (G: natural number greater than or equal to 2) by delaying the temperature measurement value Tb0 by one frame period to G frame periods.

The temperature measurement values Tb0-TbG are temperature measurement values acquired in frame periods different from each other, namely, at times different from each other, and thus are collectively referred to as temperature measurement values in a plurality of frames or temperature measurement values at a plurality of times.

Further, the temperature measurement value Tb0 in the present frame can be referred to as a present temperature measurement value, and the temperature measurement values Tb1 TbG one or more frames earlier can be referred to as past temperature measurement values.

The temperature estimation unit 14c successively selects the plurality of light-emitting elements of the image display 2, estimates the temperature of the selected light-emitting element, and outputs the temperature estimate value Te0(x, y).

The estimated temperature storage unit 15 stores the temperature estimate value Te0(x, y) outputted from the temperature estimation unit 14c, delays the temperature estimate value Te0(x, y) by one frame period, and outputs the delayed temperature estimate value Te0(x, y) as the temperature estimate value Te1(x, y) one frame earlier.

Similarly to the temperature compensation unit 16 in the first embodiment, the temperature compensation unit 16c corrects the input image data Da based on the temperatures Te0(x, y) estimated by the temperature estimation unit 14c and thereby generates and outputs corrected image data Db.

The temperature compensation unit 16c further calculates and outputs the lighting ratio Lb0 of the selected light-emitting element among the corrected image data Db.

For example, in regard to the selected light-emitting element, ratios of the R, G and B component values to a predetermined reference value are outputted as lighting ratios Lb0r, Lb0g and Lb0b.

Instead of outputting the lighting ratios Lb0r, Lb0g and Lb0b regarding R, G and B as above, it is also possible to obtain the average value of the R, G and B lighting ratios Lb0r, Lb0g and Lb0b and output the obtained average value.

The following description will be given assuming that the average value is outputted as the lighting ratio Lb0 of the selected light-emitting element.

The lighting ratio storage unit 18 delays the lighting ratio Lb0 calculated by the temperature compensation unit 16c by one frame period and outputs the delayed lighting ratio Lb0 as a lighting ratio Lb1 one frame earlier.

The temperature estimation unit 14c estimates the temperature of each light-emitting element of the image display 2 based on the input image data Da outputted from the image input unit 11, the lighting ratio Lb1 outputted from the lighting ratio storage unit 18, the temperature measurement values Tb0, Tb1 of the selected light-emitting element at a plurality of times, and the past temperature estimate values Te1.

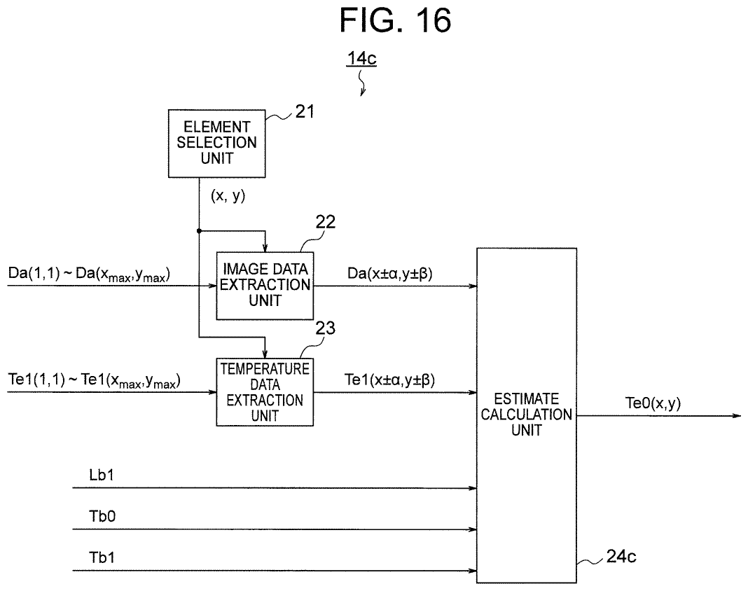

The temperature estimation unit 14c is configured as shown in FIG. 16, for example.

The temperature estimation unit 14c shown in FIG. 16 is roughly the same as the temperature estimation unit 14 shown in FIG. 4. An estimate calculation unit 24c is provided instead of the estimate calculation unit 24.

The estimate calculation unit 24c obtains the temperature estimate value Te0(x, y) of the selected light-emitting element based on the image data Da(x±α, y±β) extracted by the image data extraction unit 22, the temperature estimate values Te1(x±α, y±β) one frame earlier extracted by the temperature data extraction unit 23, the lighting ratio Lb1 outputted from the lighting ratio storage unit 18, the temperature measurement value Tb0 of the selected light-emitting element in the present frame outputted from the control-dedicated temperature measurement module 6c, and the temperature measurement value Tb1 of the selected light-emitting element one frame earlier outputted from the measured temperature storage unit 13.

The estimate calculation unit 24c is formed with a multi-layer neural network. This neural network is a neural network similar to that shown in FIG. 5. However, while the temperature measurement value Ta1 of the light emitter 5 one frame earlier and the temperature measurement value Ta0 of the light emitter 5 in the present frame are used in FIG. 5, the temperature measurement value Tb1 of the selected light-emitting element one frame earlier and the temperature measurement value Tb0 of the selected light-emitting element in the present frame are used in the neural network forming the estimate calculation unit 24c of the temperature estimation unit 14c.

Further, while the lighting ratio La0 determined by the lighting control unit 12 is used in FIG. 5, the lighting ratio Lb1 outputted from the lighting ratio storage unit 18 is used in the neural network forming the temperature estimation unit 14c.

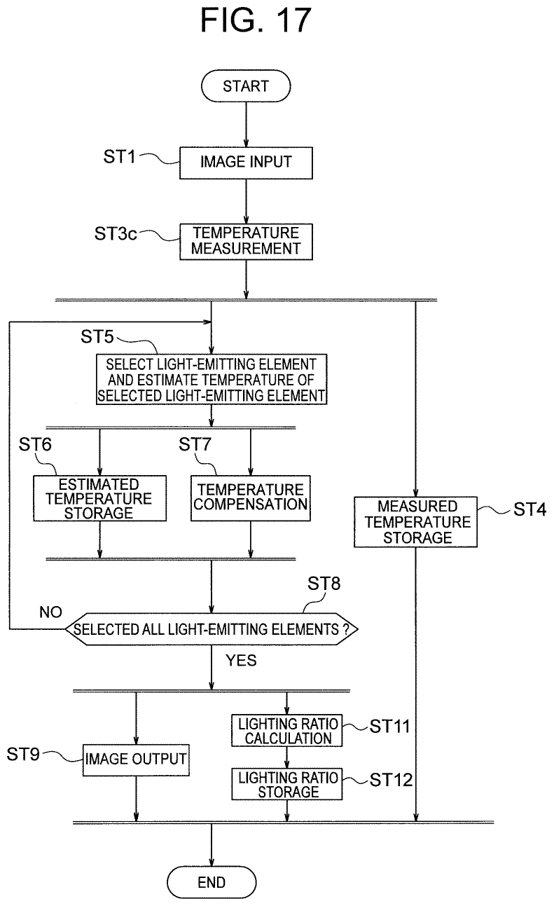

A procedure of a process executed by the processor 91 in the case where the above-described image processing device 4c is formed with the computer shown in FIG. 3 will be described below with reference to FIG. 17.

The procedure of the process of FIG. 17 is roughly the same as the procedure of the process of FIG. 8. However, the step ST2 in FIG. 8 is not included. Further, the step ST3 in FIG. 8 is replaced with step ST3c, and steps ST11 and ST12 are added.

In the step ST3c, the temperature of the selected light-emitting element of the image display 2 is measured. This process is the same as the process by the temperature estimation unit 14c in FIG. 15.

In the step ST11, the lighting ratio is calculated. This process is the same as the lighting ratio calculation process by the temperature compensation unit 16c.

In the step ST12, the calculated lighting ratio is stored. This process is the same as the process by the lighting ratio storage unit 18.

Also with the third embodiment, advantages the same as those of the first embodiment are obtained. Namely, also in the third embodiment, the changes in the luminance and the color of each light-emitting element due the temperature change can be compensated for even if the image display device does not include the temperature sensors for measuring the temperatures of light-emitting elements other than the selected light-emitting element. Further, the third embodiment has an advantage in that the configuration is simple since it is unnecessary to provide the light emitter 5 used in the first and second embodiments.

### Fourth Embodiment

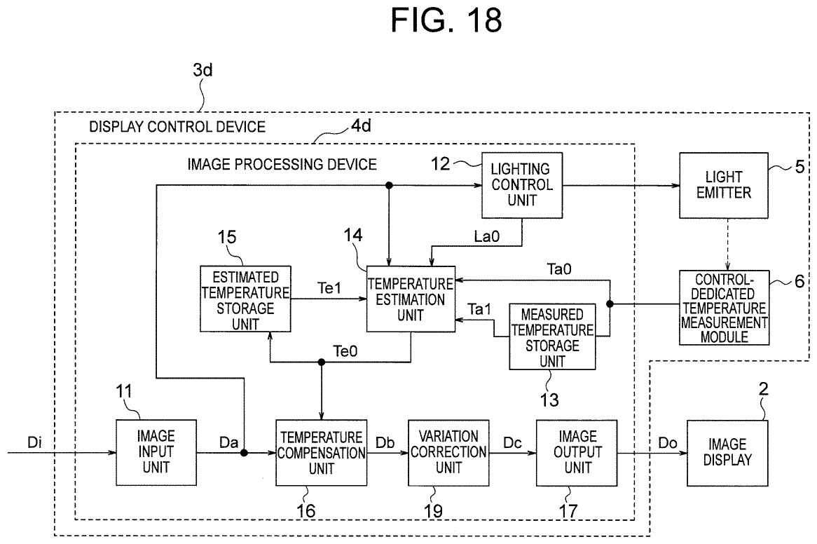

FIG. 18 shows an image display device in a fourth embodiment of the present invention. The image display device shown in FIG. 18 includes a display control device 3d. The display control device 3d is roughly the same as the display control device 3 shown in FIG. 1. However, an image processing device 4d is provided instead of the image processing device 4. While the image processing device 4d is roughly the same as the image processing device 4 shown in FIG. 1, a variation correction unit 19 is added.

The variation correction unit 19 corrects variations of each of the plurality of light-emitting elements of the image display 2. The variations mentioned here mean variations in the luminance or the color of the light generated by the light-emitting element due to individual differences.

While the temperature compensation unit 16 compensates for the changes in the luminance and the color due to the temperature, the variation correction unit 19 compensates for the variations in the luminance and the color among the light-emitting elements due to the individual differences.

In the following description, it is assumed that the image data Da regarding the plurality of light-emitting elements of the image display 2 are successively inputted from the image input unit 11 to the variation correction unit 19 in an order like from the top left corner to the bottom right corner of the screen, for example. In this case, the variation correction unit 19 handles image data Da inputted at each time point as image data Da regarding a light-emitting element that has become a processing target (targeted light-emitting element), performs the variation correction on the image data Da, and outputs corrected image data Db.

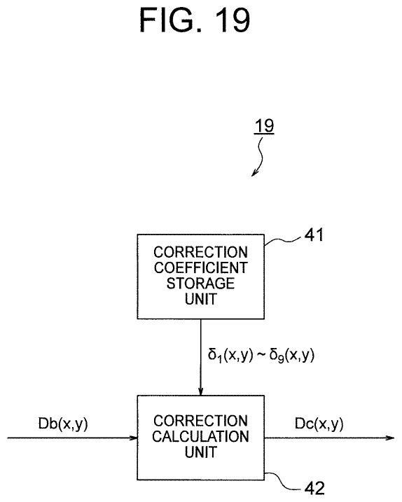

The variation correction unit 19 includes a correction coefficient storage unit 41 and a correction calculation unit 42 as shown in FIG. 19, for example.

The correction coefficient storage unit 41 has stored correction coefficients regarding each light-emitting element, namely, coefficients for correcting the variations in the luminance and the color of each light-emitting element. For example, there are nine correction coefficients δ₁-δ₉ regarding each light-emitting element. The correction coefficients regarding the light-emitting element at the position (x, y) are represented as δ₁(x, y)-δ₉(x, y).

The correction calculation unit 42 performs calculations indicated by the following expressions (3a), (3b) and (3c) on the image data Db(x, y) regarding the light-emitting element that has become the processing target by using the correction coefficients δ₁(x, y)-δ₉(x, y) regarding the light-emitting element outputted from the correction coefficient storage unit 41 and thereby generates and outputs image data Dc in which the variations of the light-emitting element have been corrected:

Rc(x,y)=δ₁(x,y)×Rb(x,y)+δ₂(x,y)×Gb(x,y)+δ₃(x,y)×Bb(x,y) expressions (3a)

Gc(x,y)=δ₄(x,y)×Rb(x,y)+δs(x,y)×Gb(x,y)+δ₆(x,y)×Bb(x,y) expressions (3b)

Bc(x,y)=δ₇(x,y)×Rb(x,y)+δs(x,y)×Gb(x,y)+δ₉(x,y)×Bb(x,y) expressions (3c)

In the expressions (3a) to (3c), Rb(x, y), Gb(x, y) and Bb(x, y) represent the red, green and blue component values of the image data Db of the light-emitting element that has become the processing target.

Rc(x, y), Gc(x, y) and Bc(x, y) represent the red, green and blue component values of the corrected image data Dc outputted from the correction calculation unit 42.

Further, δ₁(x, y)-δ₉(x, y) represent the variation correction coefficients regarding the light-emitting element that has become the processing target.

The image data Dc obtained by the correction by the correction calculation unit 42 is supplied to the image output unit 17 as the output from the variation correction unit 19.

The image output unit 17 converts the image data Dc outputted from the variation correction unit 19 into a signal in a format in conformity with the display method of the image display 2 and outputs the image signal Do after the conversion.

In a case where the light-emitting elements of the image display 2 are made to emit light by Pulse Width Modulation (PWM) driving, gradation values of the image data are converted into a PWM signal.

The image display 2 displays an image based on the image signal Do. The displayed image is an image in which the changes in the luminance and the color due to the temperature have been compensated for in regard to each pixel and the variations of the light-emitting elements have been corrected. Accordingly, an image with no luminance irregularity and color irregularity is displayed.

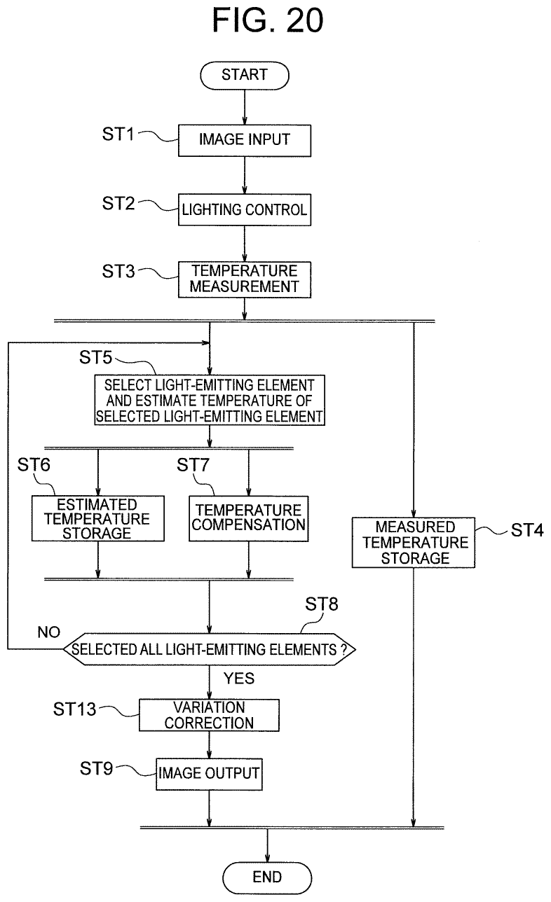

A procedure of a process executed by the processor 91 in the case where the above-described image processing device 4d is formed with the computer shown in FIG. 3 will be described below with reference to FIG. 20.

While FIG. 20 is roughly the same as FIG. 8, step ST13 is added. In the step ST13, the variation correction is executed.

This process is the same as the process by the variation correction unit 19 in FIG. 18.

A neural network used in the temperature estimation unit 14 of the image processing device 4d in the fourth embodiment is generated by means of machine learning similar to that described in the first embodiment.

Also with the fourth embodiment, advantages the same as those of the first embodiment are obtained. Further, the variations of each light-emitting element can be corrected.

### Fifth Embodiment

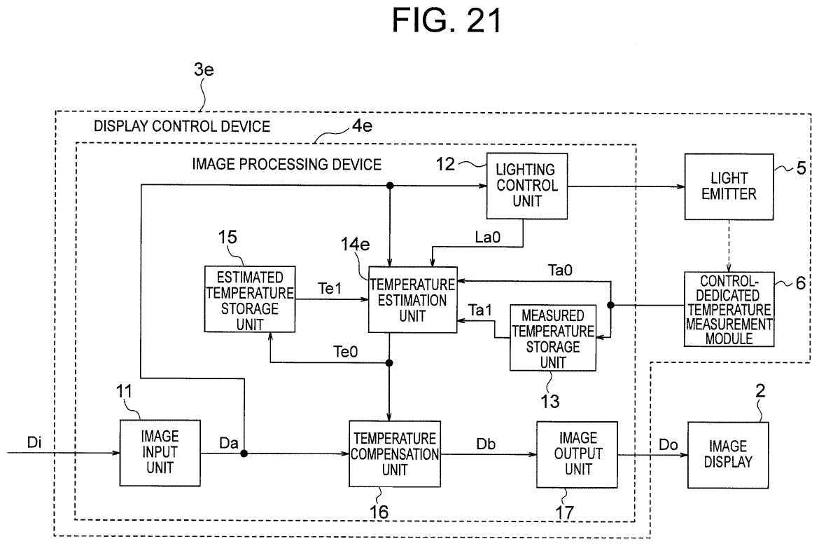

FIG. 21 shows an image display device in a fifth embodiment of the present invention. The image display device shown in FIG. 21 includes a display control device 3e. The display control device 3e is roughly the same as the display control device 3 shown in FIG. 1. However, an image processing device 4e is provided instead of the image processing device 4. The image processing device 4e is roughly the same as the image processing device 4 shown in FIG. 1. However, a temperature estimation unit 14e is provided instead of the temperature estimation unit 14.

The temperature estimation unit 14 in FIG. 1 successively selects the plurality of light-emitting elements of the image display 2 and estimates the temperature of the selected light-emitting element. In contrast, the temperature estimation unit 14e in FIG. 21 estimates the temperatures of a plurality of light-emitting elements of the image display 2 in parallel, namely, all at once. For example, the temperature estimation unit 14e estimates the temperatures of all the light-emitting elements of the image display 2 and outputs temperature estimate values Te0(1, 1)-Te0(xₘₐₓ, yₘₐₓ).

The estimated temperature storage unit 15 stores the temperature estimate values Te0(1, 1)-Te0(xₘₐₓ, yₘₐₓ) outputted from the temperature estimation unit 14e, delays the temperature estimate values Te0(1, 1)-Te0(xₘₐₓ, yₘₐₓ) by one frame period, and outputs the delayed temperature estimate values Te0(1, 1)-Te0(xₘₐₓ, yₘₐₓ) as temperature estimate values Te1(1, 1)-Te1(xₘₐₓ, yₘₐₓ) one frame earlier.

While the estimated temperature storage unit 15 has been described to output the temperature estimate values Te1 delayed by one frame period, the estimated temperature storage unit 15 may instead generate and output H sets of temperature estimate values Te1-TeH (H: natural number greater than or equal to 2) by delaying the temperature estimate values Te0 by one frame period to H frame periods.

The temperature estimate values Te0-TeH are temperature estimate values in frame periods different from each other, namely, at times different from each other, and thus are collectively referred to as temperature estimate values in a plurality of frames or at a plurality of times.

Further, the temperature estimate values Te0 in the present frame can be referred to as present temperature estimate values, and the temperature estimate values Te1-TeH one or more frames earlier can be referred to as past temperature estimate values.

The temperature estimation unit 14e obtains the temperature estimate values Te0(1, 1)-Te0(xₘₐₓ, yₘₐₓ) of all the light-emitting elements forming the image display 2 based on the input image data Da(1, 1)-Da(xₘₐₓ, yₘₐₓ) outputted from the image input unit 11, the lighting ratio La0 determined by the lighting control unit 12, the temperature measurement value Ta0 in the present frame outputted from the control-dedicated temperature measurement module 6, the temperature measurement value Ta1 one frame earlier outputted from the measured temperature storage unit 13, and the temperature estimate values Te1(1, 1)-Te1(xₘₐₓ, yₘₐₓ) one frame earlier outputted from the estimated temperature storage unit 15.

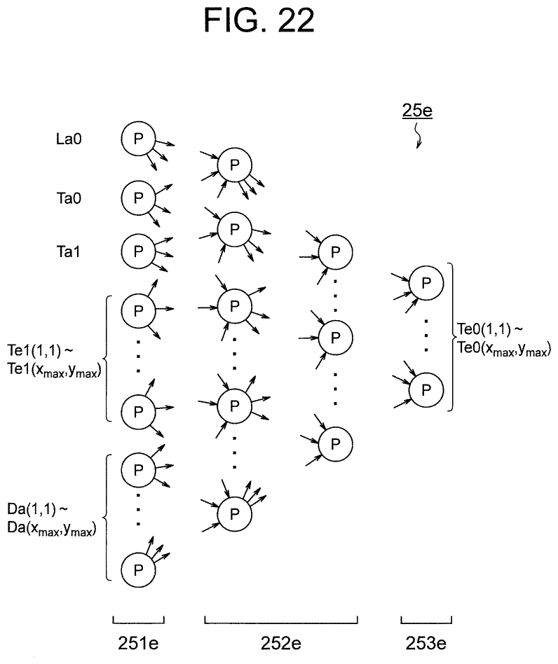

The temperature estimation unit 14e includes a multi-layer neural network. FIG. 22 shows an example of such a multi-layer neural network 25e.

The neural network 25e shown in FIG. 22 includes an input layer 251e, intermediate layers (hidden layers) 252e and an output layer 253e. While the number of intermediate layers is two in the illustrated example, the number of intermediate layers can also be one, or three or more.

Each neuron P in the input layer 251e is assigned one of the lighting ratio La0, the temperature measurement values Ta0, Ta1 at a plurality of times, the past temperature estimate values Te0(1, 1)-Te0(xₘₐₓ, yₘₐₓ), namely, the temperature estimate values respectively regarding all the light-emitting elements, and the input image data Da(1, 1)-Da(xₘₐₓ, yₘₐₓ), namely, the image data (pixel values) respectively regarding all the light-emitting elements, and the assigned value (lighting ratio, temperature measurement value, temperature estimate value or input image data) is inputted to each neuron. Each neuron in the input layer 251e outputs the input without change.

Neurons P in the output layer 253e are provided respectively corresponding to all the light-emitting elements of the image display 2. Each neuron P in the output layer 253e is formed of a plurality of bits such as 10 bits, for example, and outputs data indicating the temperature estimate value of the corresponding light-emitting element.

In FIG. 22, the temperature estimate values of the light-emitting elements at the positions (1, 1) to (xₘₐₓ, yₘₐₓ) are represented by reference characters Te0(1, 1)-Te0(xₘₐₓ, yₘₐₓ).

Each neuron P in the intermediate layer 252e or the output layer 253e performs the calculation indicated by the aforementioned expression (1) on a plurality of inputs:

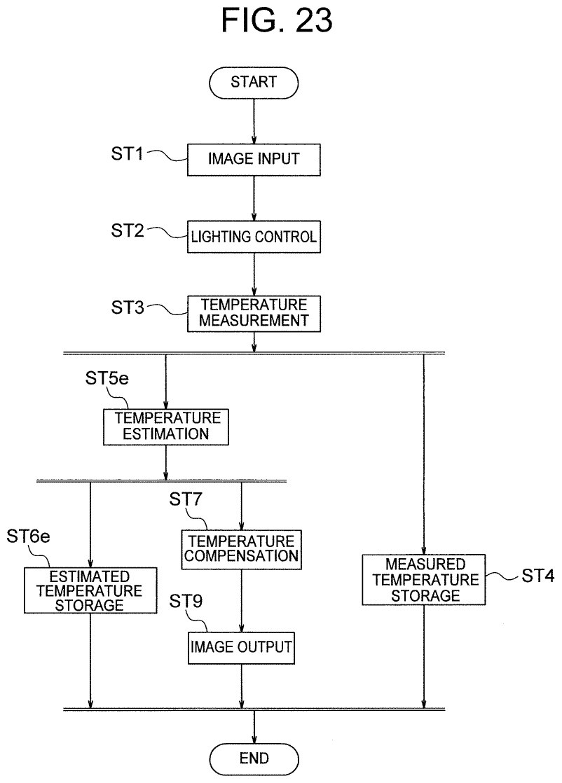

A procedure of a process executed by the processor 91 in the case where the above-described image processing device 4e is foamed with the computer shown in FIG. 3 will be described below with reference to FIG. 23.

While FIG. 23 is roughly the same as FIG. 8, the step ST8 is not included and the steps ST5 and ST6 are replaced with steps ST5e and ST6e.

In the step ST5e, the temperatures of all the light-emitting elements of the image display 2 are estimated. This process is the same as the process by the temperature estimation unit 14e in FIG. 21.

In the step ST6e, the temperature estimate values of all the light-emitting elements of the image display 2 are stored.

This process is the same as the process by the estimated temperature storage unit 15 in FIG. 21.

The neural network foaming the temperature estimation unit 14e, that is, the neural network shown in FIG. 22, is generated by means of machine learning.

The learning device for the machine learning is connected to the image display device of FIG. 21 and used.

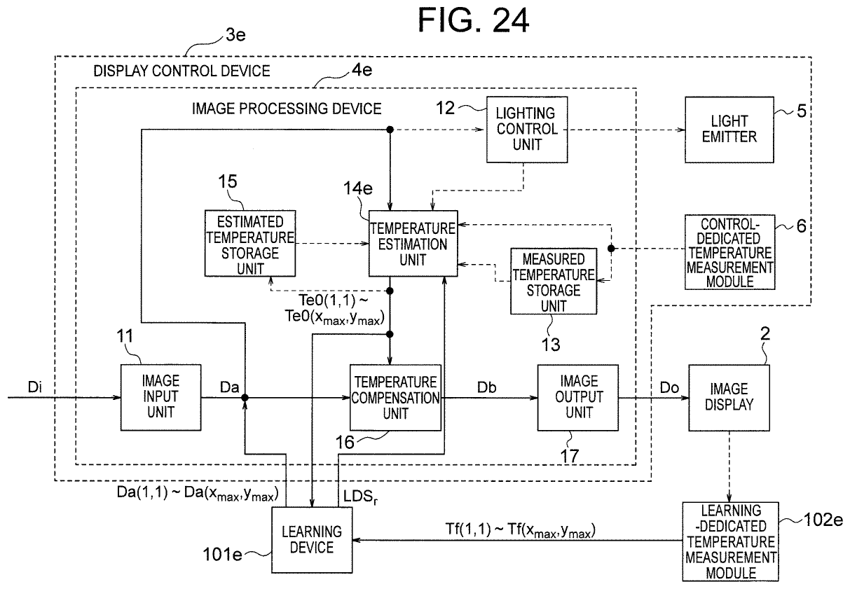

FIG. 24 shows the learning device 101e connected to the image display device of FIG. 21. FIG. 24 also shows a learning-dedicated temperature measurement module 102e used together with the learning device 101e.

The learning-dedicated temperature measurement module 102e measures the temperatures of all the light-emitting elements of the image display 2 and outputs temperature measurement values Tf(1, 1)-Tf(xₘₐₓ, yₘₐₓ).

The learning-dedicated temperature measurement module 102e includes a plurality of temperature sensors. The plurality of temperature sensors are provided respectively corresponding to all the light-emitting elements forming the image display 2, and each temperature sensor measures and outputs the temperature Tf of the corresponding light-emitting element.

Each of the temperature sensors forming the learning-dedicated temperature measurement module 102e may have the same configuration as the temperature sensor forming the learning-dedicated temperature measurement module 102 used in the first embodiment.

Instead, it is also possible for the learning-dedicated temperature measurement module 102e to include a single thermal image sensor, measure temperature distribution of a display screen of the image display 2, and obtain the temperature of each light-emitting element by associating positions in the thermal image with positions on the display screen of the image display 2.

The learning device 101e may be formed with a computer. In the case where the image processing device 4e is forced with a computer, the learning device 101e may be formed with the same computer. The computer forming the learning device 101e may be the computer shown in FIG. 3, for example. In that case, the function of the learning device 101e may be implemented by the processor 91 by executing a program stored in the memory 92.

The learning device 101e makes a part of the image processing device 4e operate, makes the temperature estimation unit 14e estimate the temperatures of all the light-emitting elements, and executes the learning so that the temperature estimate values Te0(1, 1)-Te0(xₘₐₓ, yₘₐₓ) become close to the temperature measurement values Tf(1, 1)-Tf(xₘₐₓ, yₘₐₓ) of all the light-emitting elements obtained by the measurement by the learning-dedicated temperature measurement module 102e.

For the learning, a plurality of sets LDS of learning input data are used.

Each of the learning input data sets includes input image data Da(1, 1)-Da(xₘₐₓ, yₘₐₓ), a lighting ratio La0, a temperature measurement value Ta0 in the present frame, a temperature measurement value Ta1 one frame earlier and temperature estimate values Te1(1, 1)-Te1(xₘₐₓ, yₘₐₓ) one frame earlier that have been prepared for the learning.

Between the plurality of learning input data sets LDS, at least one of the input image data Da(1, 1)-Da(xₘₐₓ, yₘₐₓ), the lighting ratio La0, the temperature measurement value Ta0 in the present frame, the temperature measurement value Ta1 one frame earlier and the temperature estimate values Te1(1, 1)-Te1(xₘₐₓ, yₘₐₓ) one frame earlier differs from each other.

The learning device 101e successively selects the plurality of learning input data sets LDS previously prepared, inputs the selected learning input data set LDS to the image processing device 4e, acquires the temperature estimate values Te0(1, 1)-Te0(xₘₐₓ, yₘₐₓ) calculated by the temperature estimation unit 14e and the temperature measurement values Tf(1, 1)-Tf(xₘₐₓ, yₘₐₓ) obtained by the measurement by the learning-dedicated temperature measurement module 102e, and executes the learning so that the temperature estimate values Te0(1, 1)-Te0(xₘₐₓ, yₘₐₓ) become close to the temperature measurement values Tf(1, 1)-Tf(xₘₐₓ, yₘₐₓ).

To “input the selected learning input data set LDS to the image processing device 4e” means to input the image data Da(1, 1)-Da(xₘₐₓ, yₘₐₓ) included in the selected learning input data set LDS to the lighting control unit 12, the temperature estimation unit 14e and the temperature compensation unit 16 and input the lighting ratio La0, the temperature measurement value Ta0 in the present frame, the temperature measurement value Ta1 one frame earlier and the temperature estimate values Te1(1, 1)-Te1(xₘₐₓ, yₘₐₓ) one frame earlier included in the selected learning input data set LDS to the temperature estimation unit 14e.

In the generation of the neural network by the learning device 101e, the neural network as the base is prepared first. Namely, the temperature estimation unit 14e is provisionally constructed with the neural network as the base. While this neural network is a neural network similar to that shown in FIG. 22, each of the neurons in the intermediate layer and the output layer is connected to all the neurons in the layer in front.

In the generation of the neural network, it is necessary to set the values of the parameters (the weights and the bias) for each of the plurality of neurons. A set of parameters regarding the plurality of neurons is referred to as the parameter set and is represented by the reference character PS.

In the generation of the neural network, optimization of the parameter set PS is executed by using the aforementioned neural network as the base so that the sum of the differences of the temperature estimate values Te0(1, 1)-Te0(xₘₐₓ, yₘₐₓ) of all the light-emitting elements from the temperature measurement values Tf(1, 1)-Tf(xₘₐₓ, yₘₐₓ) becomes less than or equal to a predetermined threshold value. The optimization can be executed by the error back propagation method, for example.

Specifically, the learning device 101e prepares a plurality of learning input data sets LDS, sets initial values of the parameter set PS, and successively selects the learning input data sets LDS.

The learning device 101e inputs the selected learning input data set LDS to the image processing device 4e and obtains the sum of the differences (Te0(x, y)-Tf(x, y)) between the temperature measurement values Tf(1, 1)-Tf(xₘₐₓ, yₘₐₓ) of all the light-emitting elements and the temperature estimate values Te0(1, 1)-Te0(xₘₐₓ, yₘₐₓ) as an error ER.

The learning device 101e obtains the sum total ES of the aforementioned errors ER regarding the plurality of learning data sets LDS as the cost function, and if the cost function is greater than a threshold value, changes the parameter set PS so that the cost function becomes smaller.

The learning device 101e repeats the above-described process until the cost function becomes less than or equal to the threshold value. The changing of the parameter set PS can be executed by the gradient descent method.

As the sum total ES of the errors ER, the sum of the absolute values of the errors ER or the sum of the squares of the errors ER can be used.

Similarly, as the aforementioned sum of the differences, the sum of the absolute values of the differences (Te0(x, y)-Tf(x, y)) or the sum of the squares of the differences (Te0(x, y)-Tf(x, y)) can be used.

After the optimization of the parameter set PS, the learning device 101e disconnects synaptic connections (connections between neurons) whose weights have become zero.

After the learning is over, the temperature sensors of the learning-dedicated temperature measurement module 102e are detached and the image display device is used in the state in which those temperature sensors have been detached.

Namely, when used for displaying images, the image display device does not need the temperature sensors for detecting the temperatures of the light-emitting elements. This is because the temperatures of the light-emitting elements can be estimated by the temperature estimation unit 14e even without the temperature sensors for detecting the temperatures of the light-emitting elements.

After the learning is over, the learning device 101e may be either detached or left attached.

Especially in a case where the function of the learning device 101e is implemented by the execution of a program by the processor 91, the program may be left stored in the memory 92.

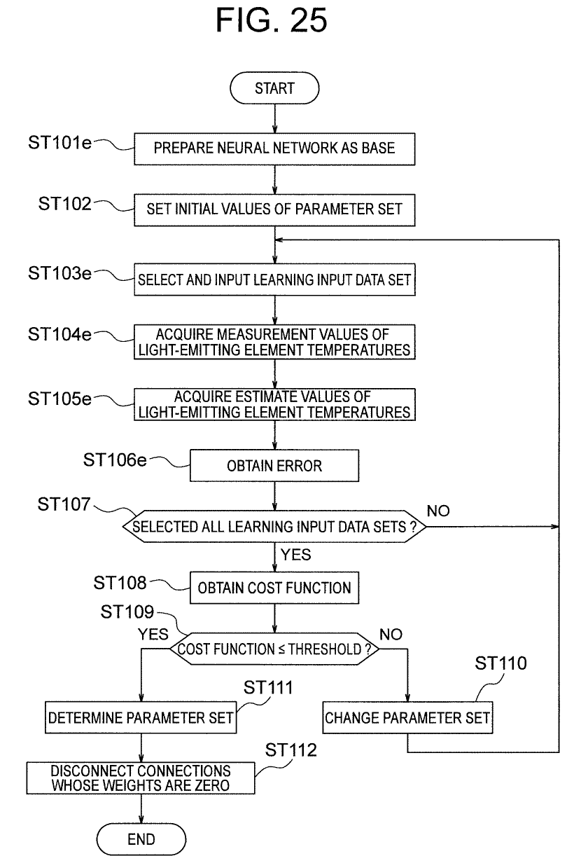

A procedure of a process executed by the processor 91 in the case where the above-described learning device 101e is formed with the computer shown in FIG. 3 will be described below with reference to FIG. 25.

The procedure of the process of FIG. 25 is roughly the same as the procedure of the process of FIG. 10. However, the steps ST101 and ST103 to ST106 in FIG. 10 are replaced with steps ST101e and ST103e to ST106e.

In step ST101e in FIG. 25, the learning device 101e prepares the neural network as the base. Namely, the temperature estimation unit 14e is provisionally constructed with the neural network as the base.

While this neural network is a neural network similar to that shown in FIG. 22, each of the neurons in the intermediate layer or the output layer is connected to all the neurons in the layer in front.

In the step ST102, the learning device 101e sets the initial values of the set PS of parameters (weights and biases) used in the calculations in the neurons in the intermediate layer or the output layer of the neural network prepared in the step ST101e.

The initial values may be either values randomly selected or values expected to be appropriate.

In the step ST103e, the learning device 101e selects one learning input data set LDS from the plurality of learning input data sets LDS previously prepared, and inputs the selected learning input data set LDS to the image processing device 4e.

To “input the selected learning input data set to the image processing device 4e” means to input the image data Da(1, 1)-Da(xₘₐₓ, yₘₐₓ) included in the selected learning input data set to the lighting control unit 12, the temperature estimation unit 14e and the temperature compensation unit 16 and input the lighting ratio La0, the temperature measurement value Ta0 in the present frame, the temperature measurement value Ta1 one frame earlier and the temperature estimate values Te1(1, 1)-Te1(xₘₐₓ, yₘₐₓ) one frame earlier included in the selected learning input data set to the temperature estimation unit 14e.

The image data Da(1, 1)-Da(xₘₐₓ, yₘₐₓ) inputted to the temperature compensation unit 16 is supplied to the image display 2 via the image output unit 17 and used for driving light-emitting elements of the image display 2.

In the step ST104e, the learning device 101e acquires the temperature measurement values Tf(1, 1)-Tf(xₘₐₓ, yₘₐₓ) of all the light-emitting elements forming the image display 2.

The temperature measurement values Tf(1, 1)-Tf(xₘₐₓ, yₘₐₓ) acquired here are the temperature measurement values at the time when the image display 2 displayed an image according to the image data Da(1, 1)-Da(xₘₐₓ, yₘₐₓ) included in the selected learning input data set LDS.

In the step ST105e, the learning device 101e acquires the temperature estimate values Te0(1, 1)-Te0(xₘₐₓ, yₘₐₓ) of all the light-emitting elements forming the image display 2.

The temperature estimate values Te0(1, 1)-Te0(xₘₐₓ, yₘₐₓ) acquired here are the temperature estimate values calculated by the temperature estimation unit 14e based on the image data Da(1, 1)-Da(xₘₐₓ, yₘₐₓ), the lighting ratio La0, the temperature measurement value Ta0 in the present frame, the temperature measurement value Ta1 one frame earlier and the temperature estimate values Te1(1, 1)-Te1(xₘₐₓ, yₘₐₓ) one frame earlier included in the selected learning input data set LDS and by using the currently set parameter set PS.

The currently set parameter set PS is the set of parameters provisionally set to the neural network forming the temperature estimation unit 14e.

In the step ST106e, the learning device 101e obtains the sum of the differences between the temperature measurement values Tf(1, 1)-Tf(xₘₐₓ, yₘₐₓ) acquired in the step ST104e and the temperature estimate values Te0(1, 1)-Te0(xₘₐₓ, yₘₐₓ) acquired in step ST105e as the error ER.

In the steps ST107 to ST112 in FIG. 25, processes the same as the steps in FIG. 10 with the same reference characters are executed.

The process of generating the neural network is finished as above.

Namely, the temperature estimation unit 14e is constructed as a unit formed with the neural network generated by the above-described process.

Also with the fifth embodiment, advantages the same as those of the first embodiment are obtained. Further, an advantage is obtained in that the operation is at high speed since the temperatures of all the light-emitting elements forming the image display can be estimated all at once.

While the fifth embodiment has been described above as a modification to the first embodiment, a similar change can be applied also to the second to fourth embodiments.

### Sixth Embodiment

In the first to fifth embodiments, the temperature estimation unit is formed with a neural network as described above.

The temperature estimation unit does not necessarily have to be formed with a neural network; it is permissible if the temperature estimation unit performs the estimation of the temperatures of the light-emitting elements by using the result of machine learning in any form. For example, the temperature estimation unit can be a unit that stores a set of coefficients obtained as the result of the machine learning and estimates the temperatures of the light-emitting elements by executing a product sum calculation by using the stored set of coefficients.

In the following, an example of such a configuration will be described as a sixth embodiment.

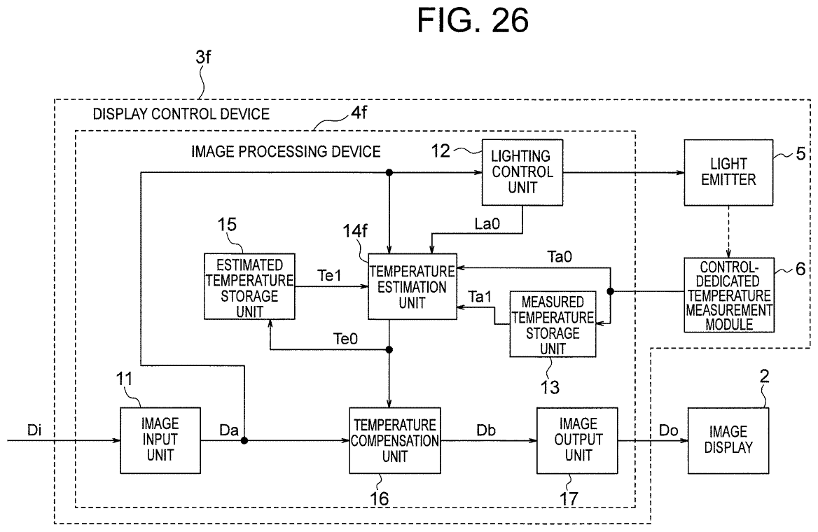

FIG. 26 shows an image display device in a sixth embodiment of the present invention. The image display device shown in FIG. 26 includes a display control device 3f. The display control device 3f is roughly the same as the display control device 3 shown in FIG. 1. However, an image processing device 4f is provided instead of the image processing device 4. The image processing device 4f shown in FIG. 26 is roughly the same as the image processing device 4 shown in FIG. 1. However, a temperature estimation unit 14f is provided instead of the temperature estimation unit 14 shown in FIG. 1.

The temperature estimation unit 14f has a function similar to that of the temperature estimation unit 14 in FIG. 1.

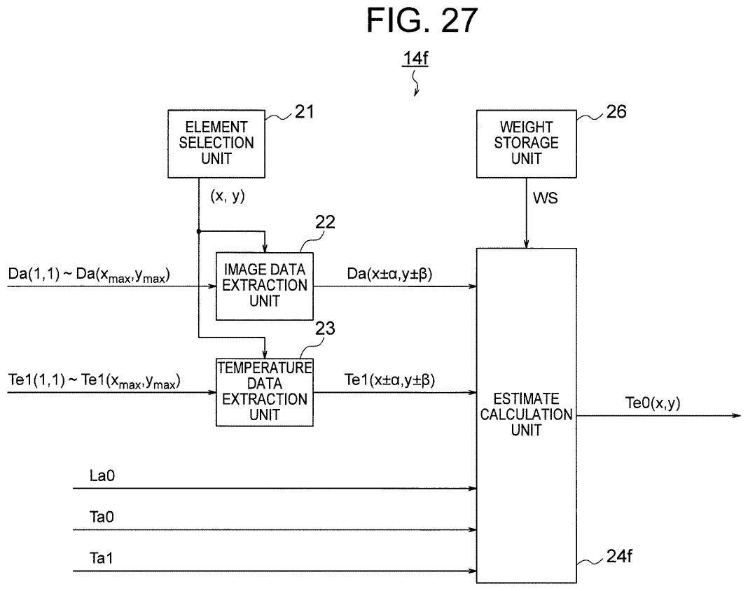

The temperature estimation unit 14f is configured as shown in FIG. 27, for example. The temperature estimation unit 14f shown in FIG. 27 is roughly the same as the temperature estimation unit 14 shown in FIG. 4. However, an estimate calculation unit 24f is provided instead of the estimate calculation unit 24 and a weight storage unit 26 is added.

The weight storage unit 26 has stored a set WS of weights.

The weight set WS includes weights ka_{α, β}, kb_{α, β}, kc, kd and ke.

The weights ka_{α,β} are weights for the image data Da(x+α, y+β). Since a changes from −αₘₐₓ to αₘₐₓ and β changes from −βₘₐₓ to βₘₐₓ, the weights ka_{α, β} include (2αₘₐₓ+1)×(2βₘₐₓ+1) weights, constituting the elements of a matrix indicated by the following expression (4), in regard to α and β at different values:

$$k {a}_{α , β} = [ \begin{matrix}{ka}_{- {α}_{max} , - {β}_{max}} & {ka}_{- {α}_{max} + 1 , - {β}_{max}} & … & {ka}_{{α}_{max} , - {β}_{max}} \\ {ka}_{- {α}_{max} , - {β}_{max} + 1} & {ka}_{- {α}_{max} + 1 , - {β}_{max} + 1} & ⋮ & {ka}_{{α}_{max} , - {β}_{max} + 1} \\ ⋮ & ⋮ & ⋱ & ⋮ \\ {ka}_{- {α}_{max} , {β}_{max}} & {ka}_{- {α}_{max} + 1 , {β}_{max}} & … & {ka}_{{α}_{max} , {β}_{max}}\end{matrix} ] \qquad expression ( 4 )$$

The weights kb_{α, β} are weights for the temperature estimate values Te1(x+α, y+β). Since a changes from −αₘₐₓ to αₘₐₓ and β changes from −βₘₐₓ to βₘₐₓ, the weights kb_{α, β} include (2αₘₐₓ+1)×(2βₘₐₓ+1) weights, constituting the elements of a matrix indicated by the following expression (5), in regard to α and β at different values:

$${kb}_{α , β} = [ \begin{matrix}{kb}_{- {α}_{max} , - {β}_{max}} & {kb}_{- {α}_{max} + 1 , - {β}_{max}} & … & {kb}_{{α}_{max} , - {β}_{max}} \\ {kb}_{- {α}_{max} , - {β}_{max} + 1} & {kb}_{- {α}_{max} + 1 , - {β}_{max} + 1} & ⋮ & {kb}_{{α}_{max} , - {β}_{max} + 1} \\ ⋮ & ⋮ & ⋱ & ⋮ \\ {kb}_{- {α}_{max} , {β}_{max}} & {kb}_{- {α}_{max} + 1 , {β}_{max}} & … & {kb}_{{α}_{max} , {β}_{max}}\end{matrix} ] \qquad expression ( 5 )$$

The estimate calculation unit 24f obtains the temperature estimate value of the selected light-emitting element by using the following expression (6), for example:

$$Te 0 ( x , y ) = {{\sum }^{{α}_{max}}}_{α = - {α}_{max}} {{\sum }^{{β}_{max}}}_{β = - {β}_{max}} Da ( x + α , y + β ) \times k {a}_{α , β} + {{\sum }^{{α}_{max}}}_{α = - {α}_{max}} {{\sum }^{{β}_{max}}}_{β = - {β}_{max}} Te 1 ( x + α , y + β ) \times k {b}_{α , β} + La 0 \times kc + Ta 0 \times kd + Ta 1 \times ke \qquad expression ( 6 )$$

In the expression (6), x represents the horizontal direction position of the selected light-emitting element and y represents the vertical direction position of the selected light-emitting element.

The weight set WS including the weights ka_{α, β}, kb_{α, β}, kc, kd and ke used in the expression (6) has been stored in the weight storage unit 26.

A procedure of a process executed by the processor 91 in the case where the above-described image processing device 4f is formed with the computer shown in FIG. 3 is similar to the procedure of the process described with reference to FIG. 8 in regard to the first embodiment. However, the procedure of the process in this embodiment differs from that in the first embodiment in that the temperature estimation in the step ST5 is the same as the process executed by the temperature estimation unit 14f.

The weight set WS stored in the weight storage unit 26 is determined or generated by means of machine learning.

The learning device for the machine learning is connected to the image display device of FIG. 26 and used.

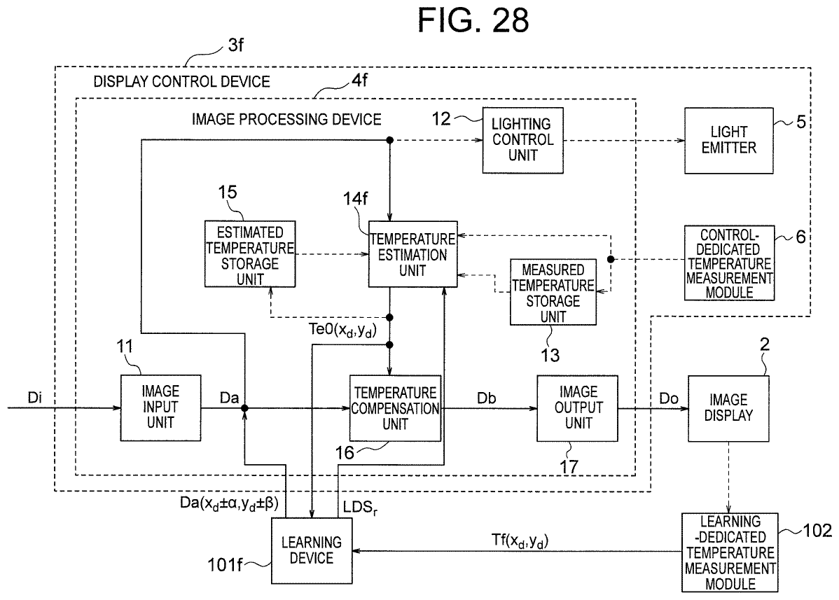

FIG. 28 shows the learning device 101f connected to the image display device of FIG. 26. FIG. 28 also shows the learning-dedicated temperature measurement module 102 used together with the learning device 101f.

The learning-dedicated temperature measurement module 102 is the same as that described with reference to FIG. 9.

The learning device 101f may be formed with a computer. In the case where the image processing device 4f is formed with a computer, the learning device 101f may be formed with the same computer. The computer forming the learning device 101f may be the computer shown in FIG. 3, for example. In that case, the function of the learning device 101f may be implemented by the processor 91 by executing a program stored in the memory 92.

The learning device 101f makes a part of the image processing device 4f operate, makes the temperature estimation unit 14f estimate the temperature of the aforementioned designated light-emitting element, and executes the learning so that the temperature estimate value Te0(x_{d}, y_{d}) becomes close to the temperature measurement value Tf(x_{d}, y_{d}) of the light-emitting element obtained by the measurement by the learning-dedicated temperature measurement module 102.

For the learning, a plurality of sets LDS of learning input data are used. The learning input data sets LDS used are the same as those described in the first embodiment.

The learning device 101f successively selects the plurality of learning input data sets LDS previously prepared, inputs the selected learning input data set LDS to the image processing device 4f, acquires the temperature estimate value Te0(x_{d}, y_{d}) calculated by the temperature estimation unit 14f and the temperature measurement value Tf(x_{d}, y_{d}) obtained by the measurement by the learning-dedicated temperature measurement module 102, and executes the learning so that the temperature estimate value Te0(x_{d}, y_{d}) becomes close to the temperature measurement value Tf(x_{d}, y_{d}).

To “input the selected learning input data set LDS to the image processing device 4f” means to input the image data Da(x_{d}±α, y_{d}±β) included in the selected learning input data set LDS to the lighting control unit 12, the temperature estimation unit 14f and the temperature compensation unit 16 and input the lighting ratio La0, the temperature measurement value Ta0 in the present frame, the temperature measurement value Ta1 one frame earlier and the temperature estimate values Te1(x_{d}±α, y_{d}±β) one frame earlier included in the selected learning input data set LDS to the temperature estimation unit 14f.

In the learning, the weight set WS is determined so that the difference of the temperature estimate value Te0(x_{d}, y_{d}) from the temperature measurement value Tf(x_{d}, y_{d}) is minimized, for example.

Specifically, the learning device 101f obtains the difference between the temperature estimate value Te0(x_{d}, y_{d}) and the temperature measurement value Tf(x_{d}, y_{d}) as an error ER, obtains the sum total ES of the aforementioned errors ER regarding the plurality of learning input data sets LDS as the cost function, and determines the weight set WS by executing the learning so that the cost function is minimized.

As the sum total ES of the errors ER, the sum of the absolute values of the errors ER or the sum of the squares of the errors ER can be used.

After the learning is over, the temperature sensors of the learning-dedicated temperature measurement module 102 are detached and the image display device is used for displaying images in the state in which those temperature sensors have been detached.

After the learning is over, the learning device 101f may be either detached or left attached.

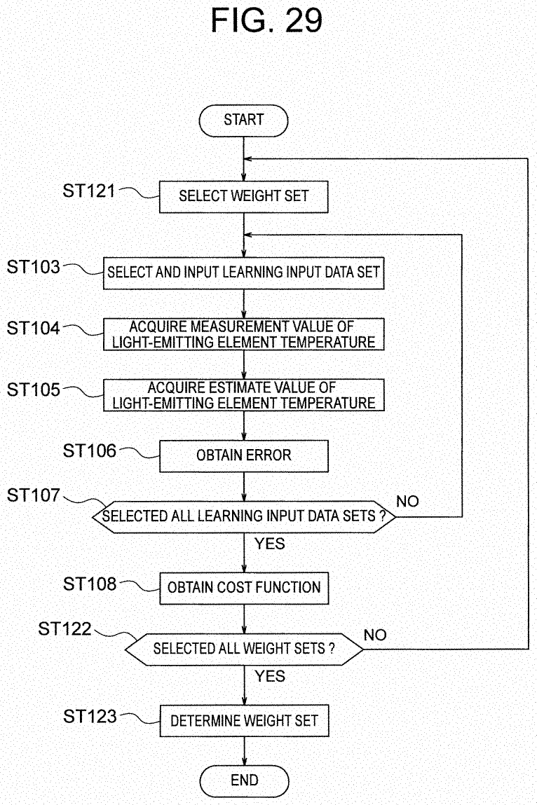

A procedure of a process executed by the processor 91 in the case where the above-described learning device 101f is formed with the computer shown in FIG. 3 will be described below with reference to FIG. 29.

The procedure of the process of FIG. 29 is roughly the same as the procedure of the process of FIG. 10. However, the steps ST101 to ST103 and ST109 to ST112 in FIG. 10 are not included and steps ST121 to ST123 are included instead.

In the step ST121, the learning device 101f selects one set from a plurality of weight sets WS previously prepared. The learning device 10 provisionally sets the selected weight set WS to the weight storage unit 26 of the temperature estimation unit 14f.

In the steps ST103 to ST108, processes the same as the steps in FIG. 10 with the same reference characters are executed.

Namely, in the step ST103, the learning device 101f selects one set from the plurality of learning input data sets LDS previously prepared and inputs the selected learning input data set to the image processing device 41.

To “input the selected learning input data set to the image processing device 4f” means to input the image data Da(x±α, y±β) included in the selected learning input data set to the lighting control unit 12, the temperature estimation unit 14f and the temperature compensation unit 16 and input the lighting ratio La0, the temperature measurement value Ta0 in the present frame, the temperature measurement value Ta1 one frame earlier and the temperature estimate values Te1(x±α, y±β) one frame earlier included in the selected learning input data set to the temperature estimation unit 14f.

The image data Da(x_{d}±α, y_{d}±β) inputted to the temperature compensation unit 16 is supplied to the image display 2 via the image output unit 17 and used for driving light-emitting elements of the image display 2.

In the step ST104, the learning device 101f acquires the temperature measurement value Tf(x_{d}, y_{d}) of the designated light-emitting element.

The temperature measurement value Tf(x_{d}, y_{d}) acquired here is the temperature measurement value at the time when the image display 2 displayed an image according to the image data Da(x_{d}±α, y_{d}±β) included in the selected learning input data set LDS.

In the step ST105, the learning device 101f acquires the temperature estimate value Te0(x_{d}, y_{d}) of the designated light-emitting element.

The temperature estimate value Te0(x_{d}, y_{d}) acquired here is the temperature estimate value calculated by the temperature estimation unit 14f based on the image data Da(x_{d}±α, y_{d}±β), the lighting ratio La0, the temperature measurement value Ta0 in the present frame, the temperature measurement value Ta1 one frame earlier and the temperature estimate values Te1(x_{d}±α, y_{d}±β) one frame earlier included in the selected learning input data set LDS and by using the selected weight set WS.

The selected weight set WS is the weight set WS provisionally set to the weight storage unit 26 in the temperature estimation unit 14f.

In the step ST106, the learning device 101f obtains the difference between the temperature measurement value Tf(x_{d}, y_{d}) acquired in the step ST104 and the temperature estimate value Te0(x_{d}, y_{d}) acquired in step ST105 as the error ER.

In the step ST107, the learning device 101f judges whether or not the processing of the steps ST103 to ST106 has been finished for all of the plurality of learning input data sets.

If the aforementioned processing has not been finished for all of the plurality of learning input data sets, the process returns to the step ST103.

Consequently, the next learning input data set LDS is selected in the step ST103 and the same process is repeated and the error ER is obtained for the selected learning input data set LDS in the steps ST104 to ST106.

If the aforementioned processing has been finished for all of the plurality of learning input data sets in the step ST107, the process advances to the step ST108.

In the step ST108, the learning device 101f obtains the sum total (sum total regarding the plurality of learning input data sets LDS) ES of the aforementioned errors ER as the cost function.

As the sum total ES of the errors ER, the sum of the absolute values of the errors ER or the sum of the squares of the errors ER can be used.

Subsequently, in step ST122, the learning device 101f judges whether or not all of the plurality of weight sets WS have been selected.

If not all have been selected, the process returns to the step ST121.

In this case, in the step ST121, a set not selected yet is selected from the weight sets WS.

If all have been selected in the step ST122, the process advances to the step ST123.

In the step ST123, the learning device 101f employs the weight set WS minimizing the cost function obtained in the aforementioned step ST108 as an optimum set.

The learning device 101f writes the weight set WS as the employed set to the weight storage unit 26.

The process of optimizing the weight set is finished as above.

Also with the sixth embodiment, advantages the same as those of the first embodiment are obtained. Further, the temperature estimation unit can be formed in a simpler configuration since no neural network is used.

While the sixth embodiment has been described above as a modification to the first embodiment, a similar change can be applied also to the second to fifth embodiments.

While embodiments of the present invention have been described above, the present invention is not limited to these embodiments and a variety of modifications are possible.

For example, modifications described in the explanation of the first embodiment are applicable also to the second to sixth embodiments.

While the light-emitting element is formed with three LEDs of red, green and blue in the first to sixth embodiments, the number of LEDs forming the light-emitting element is not limited to 3. In short, it is permissible if the light-emitting element is formed with a plurality of LEDs.

Further, while the display control device has been described as a device that makes compensation regarding both the luminance and the color, it is permissible if the display control device is a device that makes compensation regarding at least one of the luminance and the color.

Namely, it is permissible if the temperature compensation unit 16 or 16c is a unit that compensates for the change in at least one of the luminance and the color due to the temperature change, and it is permissible if the variation correction unit 19 is a unit that compensates for the variations in at least one of the luminance and the color due to the individual differences among the light-emitting elements.

While the learning device executing the learning inputs the image data Da to the lighting control unit 12, the temperature estimation unit 14, 14b, 14c, 14e or 14f and the temperature compensation unit 16 or 16c in the above-described first to sixth embodiments, the learning device may instead input image data Di corresponding to the image data Da to the image input unit 11.

While the image display devices, the display control devices and the image processing devices according to the present invention have been described above, display control methods executed by the above-described display control devices and image processing methods executed by the above-described image processing devices also constitute a part of the present invention. Further, a program that causes a computer to execute a process in the above-described display control device, image processing device, display control method or image processing method and a computer-readable record medium, such as a nontemporary record medium, recording the program also constitute a part of the present invention.

### DESCRIPTION OF REFERENCE CHARACTERS

2: image display, 3, 3b, 3c, 3d, 3e, 3f: display control device, 4, 4b, 4c, 4d, 4e, 4f: image processing device, 5: light emitter, 6, 6c: control-dedicated temperature measurement module, 9: computer, 11: image input unit, 12: lighting control unit, 13: measured temperature storage unit, 14, 14b, 14c, 14e, 14f: temperature estimation unit, 15: estimated temperature storage unit, 16, 16c: temperature compensation unit, 17: image output unit, 18: lighting ratio storage unit, 19: variation correction unit, 21: element selection unit, 22: image data extraction unit, 23: temperature data extraction unit, 24, 24b, 24c, 24f: estimate calculation unit, 25, 25b, 25e: neural network, 26: weight storage unit, 31: compensation table storage unit, 32: coefficient readout unit, 33: coefficient multiplication unit, 41: correction coefficient storage unit, 42: correction calculation unit, 91: processor, 92: memory, 101, 101e, 101f: learning device, 102, 102e: learning-dedicated temperature measurement module, 251, 251b, 251e: input layer, 252, 252b, 252e: intermediate layer, 253, 253b, 253e: output layer.

1. An image display device comprising:
an image display in which a plurality of light-emitting elements each including a plurality of LEDs are arranged;
an image processing device to make the image display display an image according to input image data; and
a control-dedicated temperature measurement module to measure a temperature of a light emitter having a same property as the plurality of light-emitting elements of the image display or a light-emitting element selected among the plurality of light-emitting elements of the image display, wherein
the image processing device estimates a temperature of each of the plurality of light-emitting elements of the image display based on a lighting ratio of the light emitter or the selected light-emitting element, the temperature measured by the control-dedicated temperature measurement module, and the input image data,
the image processing device corrects the input image data based on the estimated temperature so that a change in at least one of luminance and color due to a temperature change is compensated for in regard to each of the plurality of light-emitting elements of the image display, and
the estimation of the temperature is performed based on a relationship among the input image data, the lighting ratio of the light emitter or the selected light-emitting element, a temperature measurement value of the light emitter or the selected light-emitting element, and a temperature measurement value of at least one light-emitting element of the image display.

2. A display control device comprising:
an image processing device to make an image display, in which a plurality of light-emitting elements each including a plurality of LEDs are arranged, display an image according to input image data; and
a control-dedicated temperature measurement module to measure a temperature of a light emitter having a same property as the plurality of light-emitting elements of the image display or a light-emitting element selected among the plurality of light-emitting elements of the image display, wherein
the image processing device estimates a temperature of each of the plurality of light-emitting elements of the image display based on a lighting ratio of the light emitter or the selected light-emitting element, the temperature measured by the control-dedicated temperature measurement module, and the input image data,
the image processing device corrects the input image data based on the estimated temperature so that a change in at least one of luminance and color due to a temperature change is compensated for in regard to each of the plurality of light-emitting elements of the image display, and
the estimation of the temperature is performed based on a relationship among the input image data, the lighting ratio of the light emitter or the selected light-emitting element, a temperature measurement value of the light emitter or the selected light-emitting element, and a temperature measurement value of at least one light-emitting element of the image display.

3. The display control device according to claim 2, wherein the image processing device determines the lighting ratio of the light emitter based on the input image data and makes the light emitter light up according to the determined lighting ratio.

4. The display control device according to claim 3, wherein the image processing device calculates an average value of the input image data across one frame period and determines a ratio of the calculated average value to a predetermined reference value as the lighting ratio.

5. The display control device according to claim 2, wherein the light emitter is arranged in a vicinity of the image display.

6. The display control device according to claim 2, wherein the image processing device calculates the lighting ratio of the selected light-emitting element based on the corrected image data.

7. The display control device according to claim 2, wherein the image processing device performs the estimation of the temperature also based on a previously estimated temperature.

8. The display control device according to claim 2, wherein the image processing device performs the estimation of the temperature also based on a temperature previously measured by the control-dedicated temperature measurement module.

9. The display control device according to claim 2, wherein
the image processing device includes a neural network for the estimation of the temperature, and
the neural network is a neural network generated by means of learning performed by using a plurality of learning input data sets each including input image data, a lighting ratio of the light emitter or the selected light-emitting element, and a temperature measurement value of the light emitter or the selected light-emitting element.

10. The display control device according to claim 2, wherein the image processing device also corrects variations in at least one of the luminance and the color of each light-emitting element due to individual differences.

11. An image processing device to make an image display, in which a plurality of light-emitting elements each including a plurality of LEDs are arranged, display an image according to input image data, the image processing device comprising:
a temperature estimating circuitry to estimate a temperature of each of the plurality of light-emitting elements of the image display based on a lighting ratio of a light emitter having a same property as the plurality of light-emitting elements of the image display or a light-emitting element selected among the plurality of light-emitting elements of the image display, a temperature of the light emitter or a temperature measurement value of the selected light-emitting element, and the input image data, and
a temperature compensating circuitry to correct the input image data based on the estimated temperature so that a change in at least one of luminance and color due to a temperature change is compensated for in regard to each of the plurality of light-emitting elements of the image display,
wherein the temperature estimating circuitry performs the estimation of the temperature based on a relationship among the input image data, the lighting ratio of the light emitter or the selected light-emitting element, a temperature measurement value of the light emitter or the selected light-emitting element, and a temperature measurement value of at least one light-emitting element of the image display.

12. (canceled)

13. A non-transitory computer-readable recording medium recording the program being for making a computer execute a process in the image processing device according to claim 11.

14. The image display device according to claim 1, wherein the estimation of the temperature by the image processing device is performed based on a performing result of machine learning by a learning device which performs the machine learning by using input-output data being input data and output data, the input data being the input image data, the lighting ratio of the light emitter or the selected light-emitting element, and a temperature measurement value of the light emitter or the selected light-emitting element, the output data being a temperature estimate value which is estimated an temperature measurement value of at least one light-emitting element of the image display.

15. The image processing device according to claim 11, wherein the estimation of the temperature by the temperature estimating circuitry is performed based on a performing result of machine learning by a learning device which performs the machine learning by using input-output data being input data and output data, the input data being the input image data, the lighting ratio of the light emitter or the selected light-emitting element, and a temperature measurement value of the light emitter or the selected light-emitting element, the output data being a temperature estimate value which is estimated an temperature measurement value of at least one light-emitting element of the image display.
